(19) United States
(12) Patent Application Publication
(10) Pub. No.: US 2026/0313477 A1
(43) Pub. Date: Oct. 8, 2026

(54) CHANNEL STATE INFORMATION (CSI) REPORT FOR LAYER 1-LAYER 2 INTER-CELL MOBILITY

(71) Applicant: Telefonaktiebolaget LM Ericsson (publ), Stockholm (SE)

(72) Inventors: Icaro Leonardo DA SILVA, Solna (SE); Daniele DAVOLI, Stockholm (SE); Andreas NILSSON, Göteborg (SE); Claes TIDESTAV, Bålsta (SE); Antonino ORSINO, Kirkkonummi (FI)

(21) Appl. No.: 18/998,377

(22) PCT Filed: Aug. 9, 2023
(86) PCT No.: PCT/SE2023/050798

§ 371 Date: Jan. 24, 2025

Related U.S. Application Data
(60) Provisional application No. 63/396,498, filed on Aug. 9, 2022.

(51) Int. Cl. H04W 36/00; H04B 7/06

(52) U.S. Cl. CPC H04W 36/0058; H04B 7/0626

(57) ABSTRACT

A method, system and apparatus are disclosed. A wireless device configured to communicate with a network node is provided. The wireless device is configured to perform a first beam measurement of a serving cell and a second beam measurement associated with an inter-cell mobility candidate cell, determine at least one event criterion is met based on at least one of the first beam measurement and the second beam measurement, and trigger at least one measurement report in a layer lower than a radio resource control, RRC, layer based on the determination.

### TECHNICAL FIELD

The present disclosure relates to wireless communications, and in particular, to event based reports associated with Layer 1/Layer 2 (L1/L2) inter-cell mobility.

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WD), as well as communication between network nodes and between WDs. Sixth Generation (6G) wireless communication systems are also under development.

### CSI Measurement Configuration for Beam Management (BM)

In 5G New Radio (NR), to support beam management operation, a wireless device is configured by the network node with a Channel State Information (CSI) measurement configuration, e.g., information element (IE) CSI-MeasConfig received within an radio resource control reconfiguration (RRCReconfiguration) message, which is configured per Serving Cell (within ServingCellConfig, e.g., of an SpCell), to associate a serving cell in which CSI reports are to be transmitted, e.g., Uplink (UL) channels of that serving cell. The signaling is defined in, for example, 3GPP TS 38.331.

For each type of channel state information (CSI) report the wireless device may need to transmit, the network node indicates an explicit list of CSI resources (also called CSI resource configuration(s)), including a list of reference signals to be measured, such as CSI-reference signals (RSs) sets (nzp-CSI-RS-ResourceSetList, information element (IE) SEQUENCE (SIZE (1 . . . maxNrofNZP-CSI-RS-ResourceSetsPerConfig)) OF NZP-CSI-RS-ResourceSetId) and/or synchronization signal blocks (SSBs) sets (csi-SSB-ResourceSetList, IE SEQUENCE (SIZE (1 . . . maxNrofCSI-SSB-ResourceSetsPerConfig)) OF CSI-SSB-ResourceSetId) for a given serving cell the wireless device is configured with, e.g., the SpCell of a cell group, or an SCell. The wireless device may measure CSI resources of a first serving cell and report in another serving cell.

The IE in which the CSI resource configuration(s) is provided to the wireless device is described below:

### CSI-ResourceConfig Information Element

-- ASN1START
-- TAG-CSI-RESOURCECONFIG-START

| | |
|---|---|
| CSI-ResourceConfig ::= | SEQUENCE { |
| csi-ResourceConfigId | CSI-ResourceConfigId, |
| csi-RS-ResourceSetList | CHOICE { |
| nzp-CSI-RS-SSB | SEQUENCE { |

nzp-CSI-RS-ResourceSetList SEQUENCE (SIZE (1..maxNrofNZP-CSI-RS-
ResourceSetsPerConfig)) OF NZP-CSI-RS-ResourceSetId

| | |
|---|---|
| | OPTIONAL, -- Need R |
| csi-SSB-ResourceSetList | SEQUENCE (SIZE (1..maxNrofCSI-SSB- |

ResourceSetsPerConfig)) OF CSI-SSB-ResourceSetId OPTIONAL -- Need R
},

| | |
|---|---|
| csi-IM-ResourceSetList | SEQUENCE (SIZE (1..maxNrofCSI-IM- |

ResourceSetsPerConfig)) OF CSI-IM-ResourceSetId
},

| | |
|---|---|
| bwp-Id | BWP-Id, |
| resourceType | ENUMERATED { aperiodic, semiPersistent, periodic }, |

...
}
-- TAG-CSI-RESOURCECONFIG-STOP
-- ASN1STOP
-----------------------------

CSI resources to be measured (or resource set with one or more RSs, indicated by SSB indexes and/or CSI-RS resource identifiers) are associated in the configuration to a CSI reporting configuration (CSI-ReportConfig), which configures an instance of a CSI report. A CSI report from the wireless device assists the network node to perform beam management operations, such as the activation (and/or deactivation) of a beam to transmit data and/or control channels to the wireless device (or a beam switching). In 5G NR terminology, the activation of a beam may be referred as the activation of a Transmission Configuration Indication (TCI) state, which is associated to a Quasi-Co-Location (QCL) source, corresponding to a Reference Signal such as an SSB and/or CSI-RS, transmitted in a spatial direction (beam) correlated to the same spatial direction (beam) in which the network node may transmit a control (e.g., physical downlink control channel (PDCCH)) and/or data channel (e.g., physical downlink shared channel (PDSCH)).

The CSI reporting configuration is used to configure a periodic or semi-persistent report sent on physical uplink control channel (PUCCH) on the serving cell in which the CSI-ReportConfig is included, or to configure a semi-persistent or aperiodic report sent on PUSCH triggered by Downlink Control Indication (DCI) received on the cell in which the CSI-ReportConfig is included (in this case, the cell on which the report is sent is determined by the received DCI).

### CSI-ReportConfig Information Element

-- ASN1START
-- TAG-CSI-REPORTCONFIG-START

| | |
|---|---|
| CSI-ReportConfig ::= | SEQUENCE { |
| reportConfigId | CSI-ReportConfigId, |
| carrier | ServCellIndex OPTIONAL, -- Need S |
| resourcesForChannelMeasurement | CSI-ResourceConfigId, |
| csi-IM-ResourcesForInterference | CSI-ResourceConfigId OPTIONAL, -- |

Need R

| | |
|---|---|
| nzp-CSI-RS-ResourcesForInterference | CSI-ResourceConfigId OPTIONAL, - |

- Need R

| | |
|---|---|
| reportConfigType | CHOICE { |
| periodic | SEQUENCE { |
| reportSlotConfig | CSI-ReportPeriodicityAndOffset, |
| pucch-CSI-ResourceList | SEQUENCE (SIZE (1..maxNrofBWPs)) |

OF PUCCH-CSI-Resource
},

| | |
|---|---|
| semiPersistentOnPUCCH | SEQUENCE { |
| reportSlotConfig | CSI-ReportPeriodicityAndOffset, |
| pucch-CSI-ResourceList | SEQUENCE (SIZE (1..maxNrofBWPs)) |

OF PUCCH-CSI-Resource
},

| | |
|---|---|
| semiPersistentOnPUSCH | SEQUENCE { |
| reportSlotConfig | ENUMERATED {sl5, sl10, sl20, sl40, sl80, |

sl160, sl320},

| | |
|---|---|
| reportSlotOffsetList | SEQUENCE (SIZE (1.. maxNrofUL- |

Allocations)) OF INTEGER(0..32),

| | |
|---|---|
| p0alpha | P0-PUSCH-AlphaSetId |

},

| | |
|---|---|
| aperiodic | SEQUENCE { |
| reportSlotOffsetList | SEQUENCE (SIZE (1..maxNrofUL- |

```
Allocations)) OF INTEGER(0..32)
    }
  },
```

| | |
|---|---|
| reportQuantity | CHOICE { |
| none | NULL, |
| cri-RI-PMI-CQI | NULL, |
| cri-RI-i1 | NULL, |
| cri-RI-i1-CQI | SEQUENCE { |
| pdsch-BundleSizeForCSI | ENUMERATED {n2, n4} |
| OPTIONAL -- Need S | |
| }, | |
| cri-RI-CQI | NULL, |
| cri-RSRP | NULL, |
| ssb-Index-RSRP | NULL, |
| cri-RI-LI-PMI-CQI | NULL |

},
[...]

| | |
|---|---|
| groupBasedBeamReporting | CHOICE { |
| enabled | NULL, |
| disabled | SEQUENCE { |
| nrofReportedRS | ENUMERATED {n1, n2, n3, n4} |

```
OPTIONAL -- Need S
    }
  },
[...]
```

| | |
|---|---|
| csi-ReportMode-r17 | ENUMERATED {mode1, mode2} |

OPTIONAL, -- Need R

| | |
|---|---|
| numberOfSingleTRP-CSI-Model-r17 | ENUMERATED {n0, n1, n2} |

OPTIONAL, -- Need R
}
-- TAG-CSI-REPORTCONFIG-STOP
-- ASN1STOP
---------------------

As shown above, the field reportConfigType within CSI-ReportConfig indicates to the wireless device the uplink (UL) channel to transmit the report and the time domain behavior for reporting CSI measurements, which may also be referred to as beam reporting in case it includes measurements used for beam management. The configuration indicates whether the report is periodic, aperiodic or semi-persistent, and associated configurations such as periodicity.

### Multi-TRP Rel-17

In 3GPP Rel-17, 3GPP agreed on a multi-TRP (e.g., transmission reception point) feature where the wireless device would be able to have an active transmission configuration indicator (TCI) state associated to an additional physical cell ID (PCI) which is not the PCI of a serving cell, referred as inter-cell beam management.

To assist the network/network node to perform the decision on activating TCI states whose quasi co-location (QCL) source is associated to additional PCI(s), the CSI resources (or CSI resource sets) to be measured may be configured to be associated to additional PCI(s). In 3GPP Rel-17, the IE CSI-SSB-ResourceSet is used to configure one SS/PBCH block resource set which refers to SS/PBCH as indicated in ServingCellConfigCommon and ServingCellConfig, which may be associated to an additional PCI, as follows:

-- ASN1START
-- TAG-CSI-SSB-RESOURCESET-START

| | |
|---|---|
| CSI-SSB-ResourceSet ::= | SEQUENCE { |
| csi-SSB-ResourceSetId | CSI-SSB-ResourceSetId, |
| csi-SSB-ResourceList | SEQUENCE (SIZE(1..maxNrofCSI-SSB- |

```
ResourcePerSet)) OF SSB-Index,
  ...,
  [[
```

| | |
|---|---|
| servingAdditionalPCIList-r17 | SEQUENCE (SIZE(1..maxNrofCSI-SSB- |

ResourcePerSet)) OF ServingAdditionalPCIIndex-r17 OPTIONAL -- Need R
]]

| | |
|---|---|
| ServingAdditionalPCIIndex-r17 ::= | INTEGER(0..maxNrofAdditionalPCI-r17) |

-- TAG-CSI-SSB-RESOURCESET-STOP
-- ASN1STOP

CSI-SSB-ResourceSet field descriptions
servingAdditionalPCIList
Indicates the physical cell IDs (PCI) of the SSBs in the csi-SSB-ResourceList. If present, the list has the same number of entries as csi-SSB-ResourceList. The first entry of the list indicates the value of the PCI for the first entry of csi-SSB-ResourceList, the second entry of this list indicates the value of the PCI for the second entry of csi-SSB-ResourceList, and so on. For each entry, the following applies:
   If the value is zero, the PCI is the PCI of the serving cell in which this CSI-SSB-ResourceSet is defined;
   otherwise, the value is additionalPCIIndex-r17 of an SSB-MTC-AdditionalPCI-r17 in the additionalPCIList-r17 in ServingCellConfig, and the PCI is the additionalPCI-r17 in this SSB-MTC-AdditionalPCI-r17.

If the wireless device is configured with the higher layer parameter (e.g., related to NumberOfAdditionalPCI), the wireless device is allowed to report in a single reporting instance up to four SSBRIs for each report setting, where SSB resources are associated with PCI indices referring to the PCI of the serving cell and PCI(s) different from the PCI of the serving cell within the set of PCIs configured. So, even though the wireless device may include beam information associated to other PCIs, they are still PCIs associated to the same serving cell that the wireless device is configured with, and the time domain behavior for Rel-17 multi-TRP remains the same as in previous 3GPP releases, i.e., CSI reports may be period, aperiodic or semi-persistent.

### L1-L2 Based Inter-Cell Mobility in 3GPP Rel-18

In 3GPP Rel-18, 3GPP has agreed on a Work Item (WI) on Further New Radio (NR) mobility enhancements, in particular, in a technical area entitled L1/L2 based inter-cell mobility, as described in WI description (WID) in RP-213565.

According to the WID, when the wireless device moves from the coverage area of one cell to another cell, at some point a serving cell change needs to be performed. Currently, serving cell change is triggered by Open Systems Interconnection (OSI) Layer 3 (L3) measurements and is performed by RRC signalling triggered Reconfiguration with Synchronization for change of primary cell (PCell) and PSCell (primary SCG cell), as well as release add for SCells when applicable. All cases involve complete OSI Layer 2 (L2) (and OSI Layer 1 (L1)) resets, leading to longer latency, larger overhead and longer interruption time than beam switch mobility. This longer latency may go against the goal of L1/L2 mobility enhancements which is to enable a serving cell change via L1/L2 signalling, in order to reduce the latency, overhead and interruption time.

Hence, existing system and 3GPP discussion are not without issues with respect to, for example, L1/L2 based inter-cell mobility.

### SUMMARY

Some embodiments advantageously provide methods, systems, and apparatuses for event based reports associated with OSI Layer 1/Layer 2 (L1/L2) inter-cell mobility.

A method at a wireless device for triggering the transmission of lower layer measurement reports to assist L1/L2 inter-cell mobility is provided. An example method may include:
receiving an RRC message (e.g. RRC Reconfiguration) configuring at least one configuration for a lower layer measurement report including at least one event configuration indicating one or more trigger condition(s) based on a first beam measurement and/or a second beam measurement, where the first measurement is of a serving cell (e.g., PCell or PSCell) and the second measurement is of a L1/L2 inter-cell mobility candidate cell.
performing the first beam measurement and/or the second beam measurement;
upon the fulfillment of the one or more trigger condition(s), transmitting a lower layer measurement report to the network including at least the one or more of: i) the first beam measurement; ii) the second beam measurement.
A method at a network function (or network node, e.g. gNodeB) for configuring the triggering at a wireless device of lower layer measurement reports to assist L1/L2 inter-cell mobility is provided. An example method may include:
transmitting to a wireless device an RRC message configuring at least a configuration for a lower layer measurement report including at least one event configuration indicating one or more trigger condition(s) based on a first beam measurement and/or a second beam measurement to be performed by the wireless device, where the first measurement is of a serving cell (e.g. PCell) and the second measurement is of a L1/L2 inter-cell mobility candidate cell.
Receiving a lower layer measurement report from the wireless device including at least the one or more of: i) the first beam measurement; ii) the second beam measurement.

According to one aspect of the present disclosure, a method implemented in a wireless device that is configured to communicate with a network node is provided. A first beam measurement of a serving cell and a second beam measurement associated with an inter-cell mobility candidate cell is performed. A determination is made that at least one event criterion is met based on at least one of the first beam measurement and the second beam measurement. At least one measurement report is triggered in a layer lower than a radio resource control, RRC, layer based on the determination. For example, a layer lower than the RRC layer may correspond to layer 1 or layer 2.

According to some embodiments of this aspect, the measurement report is a channel state information, CSI, report. A CSI report configuration indicating the at least one event criterion is received.

According to some embodiments of this aspect, the CSI report configuration indicates a reporting configuration of at least one of at least one inter-cell mobility candidate to be measured for which measurements are compared in the at least one event criterion, and frequency information associated with at least one inter-cell mobility candidate for which measurements are compared in the at least one event criterion.

According to some embodiments of this aspect, at least one of the first beam measurement and the second beam measurement corresponds to a measurement performed on at least one of a reference signal and synchronization signal of the serving cell.

According to some embodiments of this aspect, the first beam measurement corresponds to a measurement of one of a synchronization signal block, SSB, and a channel state information-reference signal, CSI-RS, resource of the serving cell.

According to some embodiments of this aspect, the first beam measurement corresponds to the measurement of the SSB, where the SSB is one of: configured with a quasi-co-location, QCL, of an activated transmission configuration indicator, TCI, state, associated with a measurement quantity greater than measurement quantities of remaining SSBs of a plurality of SSB of the serving cell, associated with a measurement quantity greater than measurement quantities of remaining SSBs of a plurality of SSBs of the serving cell that are configured as at least one QCL source, and associated with a measurement quantity greater than measurement quantities of remaining SSBs of a plurality of SSBs of the serving cell that are configured as at least one QCL source of at least one TCI state of a current serving cell in an activated bandwidth part, BWP.

According to some embodiments of this aspect, the second beam measurement corresponds to a measurement of one of a synchronization signal block, SSB, and a channel state information-reference signal, CSI-RS, resource of the inter-cell mobility candidate cell.

According to some embodiments of this aspect, the second beam measurement corresponds to the measurement of the SSB, where the SSB is one of: configured as a quasi-co-location, QCL, of a transmission configuration indicator, TCI, state of the inter-cell mobility candidate cell, associated with a measurement quantity greater than other SSBs of a plurality of SSBs of the inter-cell mobility candidate cell, associated with a measurement quantity greater than other SSBs of a plurality of SSBs of the inter-cell mobility candidate cell that are configured as at least one QCL source of at least one TCI state, and associated with a measurement quantity greater than other SSBs of a plurality of SSBs of the inter-cell mobility candidate cell that are configured as at least one QCL source of at least one TCI state of the inter-cell mobility candidate cell having an overlapping bandwidth part, BWP, with an activated BWP of the serving cell in a same frequency of the serving cell.

According to some embodiments of this aspect, the second beam measurement corresponds to the measurement of the CSI-RS resource, where the CSI-RS resource is one of associated with a measurement quantity greater than other CSI-RS resources of a plurality of CSI-RS resources of the inter-cell mobility candidate cell, associated with a measurement quantity greater than other CSI-RS resources of a plurality of CSI-RS resources of the inter-cell mobility candidate cell that are configured as at least one QCL source of at least one TCI state, and associated with a measurement quantity greater than other CSI-RS resources of a plurality of CSI-RS resources of the inter-cell mobility candidate cell that are configured as at least one QCL source of at least one TCI state of the inter-cell mobility candidate cell having an overlapping bandwidth part, BWP, with an activated BWP of the serving cell in a same frequency of the serving cell.

According to some embodiments of this aspect, the at least one event criterion defines at least one trigger condition that is configured to trigger the measurement report, where the at least one trigger condition comprises one of the second beam measurement being offset greater than the first beam measurement, the first beam measurement is one of greater than and lower than a threshold, the second beam measurement one of greater than and lower than a threshold, and the first beam measurement is less than a first threshold and the second beam measurement is greater than a second threshold.

According to some embodiments of this aspect, the measurement report is associated with a layer lower than the radio resource control, RRC, layer.

According to some embodiments of this aspect, the measurement report is associated with one of a physical layer and medium access control layer.

According to another aspect of the present disclosure, a wireless device configured to communicate with a network node is provided. The wireless device configured to perform a first beam measurement of a serving cell and a second beam measurement associated with an inter-cell mobility candidate cell, determine at least one event criterion is met based on at least one of the first beam measurement and the second beam measurement, and trigger at least one measurement report in a layer lower than a radio resource control, RRC, layer based on the determination.

According to some embodiments of this aspect, the measurement report is a channel state information, CSI, report, and the wireless device is further configured to receive a CSI report configuration indicating the at least one event criterion.

According to some embodiments of this aspect, the CSI report configuration indicates a reporting configuration of at least one of at least one inter-cell mobility candidate to be measured for which measurements are compared in the at least one event criterion, and frequency information associated with at least one inter-cell mobility candidate for which measurements are compared in the at least one event criterion.

According to some embodiments of this aspect, at least one of the first beam measurement and the second beam measurement corresponds to a measurement performed on at least one of a reference signal and synchronization signal of the serving cell.

According to some embodiments of this aspect, the first beam measurement corresponds to a measurement of one of a synchronization signal block, SSB, and a channel state information-reference signal, CSI-RS, resource of the serving cell.

According to some embodiments of this aspect, the first beam measurement corresponds to the measurement of the SSB, where the SSB is one of: configured with a quasi-co-location, QCL, of an activated transmission configuration indicator, TCI, state, associated with a measurement quantity greater than measurement quantities of remaining SSBs of a plurality of SSB of the serving cell, associated with a measurement quantity greater than measurement quantities of remaining SSBs of a plurality of SSBs of the serving cell that are configured as at least one QCL source, and associated with a measurement quantity greater than measurement quantities of remaining SSBs of a plurality of SSBs of the serving cell that are configured as at least one QCL source of at least one TCI state of a current serving cell in an activated bandwidth part, BWP.

According to some embodiments of this aspect, the second beam measurement corresponds to a measurement of one of a synchronization signal block, SSB, and a channel state information-reference signal, CSI-RS, resource of the inter-cell mobility candidate cell.

According to some embodiments of this aspect, the second beam measurement corresponds to the measurement of the SSB, where the SSB is one of: configured as a quasi-co-location, QCL, of a transmission configuration indicator, TCI, state of the inter-cell mobility candidate cell, associated with a measurement quantity greater than other SSBs of a plurality of SSBs of the inter-cell mobility candidate cell, associated with a measurement quantity greater than other SSBs of a plurality of SSBs of the inter-cell mobility candidate cell that are configured as at least one QCL source of at least one TCI state, and associated with a measurement quantity greater than other SSBs of a plurality of SSBs of the inter-cell mobility candidate cell that are configured as at least one QCL source of at least one TCI state of the inter-cell mobility candidate cell having an overlapping bandwidth part, BWP, with an activated BWP of the serving cell in a same frequency of the serving cell.

According to some embodiments of this aspect, the second beam measurement corresponds to the measurement of the CSI-RS resource, where the CSI-RS resource is one of: associated with a measurement quantity greater than other CSI-RS resources of a plurality of CSI-RS resources of the inter-cell mobility candidate cell, associated with a measurement quantity greater than other CSI-RS resources of a plurality of CSI-RS resources of the inter-cell mobility candidate cell that are configured as at least one QCL source of at least one TCI state, and associated with a measurement quantity greater than other CSI-RS resources of a plurality of CSI-RS resources of the inter-cell mobility candidate cell that are configured as at least one QCL source of at least one TCI state of the inter-cell mobility candidate cell having an overlapping bandwidth part, BWP, with an activated BWP of the serving cell in a same frequency of the serving cell.

According to some embodiments of this aspect, the at least one event criterion defines at least one trigger condition that is configured to trigger the measurement report, where the at least one trigger condition comprises one of: the second beam measurement being offset greater than the first beam measurement, the first beam measurement is one of greater than and lower than a threshold, the second beam measurement one of greater than and lower than a threshold, and the first beam measurement is less than a first threshold and the second beam measurement is greater than a second threshold.

According to some embodiments of this aspect, the measurement report is associated with a layer lower than the radio resource control, RRC, layer.

According to some embodiments of this aspect, the measurement report is associated with one of a physical layer and medium access control layer.

According to another aspect of the present disclosure, a method implemented by a network node that is configured to communicate with a wireless device is provided. Transmission of an indication of at least one event criterion is caused where the at least one event criterion is configured to cause the wireless device to trigger a measurement report in a layer lower than a radio resource control, RRC, layer and is based on at least one of: a first beam measurement of a serving cell and a second beam measurement associated with an inter-cell mobility candidate cell for a layer lower than the RRC layer. The measurement report is received according to the at least one event criterion.

According to some embodiments of this aspect, inter-cell mobility is determined based at least on the measurement report.

According to some embodiments of this aspect, the measurement report is a channel state information, CSI, report, where the at least one event criterion is indicated in a CSI report configuration.

According to some embodiments of this aspect, the CSI report configuration indicates a reporting configuration of at least one of: at least one inter-cell mobility candidate to be measured for which measurements are compared in the at least one event criterion, and frequency information associated with at least one inter-cell mobility candidate for which measurements are compared in the at least one event criterion.

According to some embodiments of this aspect, at least one of the first beam measurement and the second beam measurement corresponds to a measurement performed on at least one of a reference signal and synchronization signal of the serving cell.

According to some embodiments of this aspect, the first beam measurement corresponds to a measurement of one of a synchronization signal block, SSB, and a channel state information-reference signal, CSI-RS, resource of the serving cell.

According to some embodiments of this aspect, the first beam measurement corresponds to the measurement of the SSB, where the SSB is one of: configured with a quasi-co-location, QCL, of an activated transmission configuration indicator, TCI, state, associated with a measurement quantity greater than measurement quantities of remaining SSBs of a plurality of SSB of the serving cell, associated with a measurement quantity greater than measurement quantities of remaining SSBs of a plurality of SSBs of the serving cell that are configured as at least one QCL source, and associated with a measurement quantity greater than measurement quantities of remaining SSBs of a plurality of SSBs of the serving cell that are configured as at least one QCL source of at least one TCI state of a current serving cell in an activated bandwidth part, BWP.

According to some embodiments of this aspect, the second beam measurement corresponds to a measurement of one of a synchronization signal block, SSB, and a channel state information-reference signal, CSI-RS, resource of the inter-cell mobility candidate cell.

According to some embodiments of this aspect, the second beam measurement corresponds to the measurement of the SSB, the SSB being one of configured as a quasi-co-location, QCL, of a transmission configuration indicator, TCI, state of the inter-cell mobility candidate cell, associated with a trigger quantity greater than other SSBs of a plurality of SSBs of the inter-cell mobility candidate cell, associated with a trigger quantity greater than other SSBs of a plurality of SSBs of the inter-cell mobility candidate cell that are configured as at least one QCL source of at least one TCI state, and associated with a trigger quantity greater than other SSBs of a plurality of SSBs of the inter-cell mobility candidate cell that are configured as at least one QCL source of at least one TCI state of the inter-cell mobility candidate cell having an overlapping bandwidth part, BWP, with a currently activated BWP of the serving cell in a same frequency of the serving cell.

According to some embodiments of this aspect, the second beam measurement corresponds to the measurement of the CSI-RS resource, where the CSI-RS resource is one of associated with a trigger quantity greater than other CSI-RS resources of a plurality of CSI-RS resources of the inter-cell mobility candidate cell, associated with a trigger quantity greater than other CSI-RS resources of a plurality of CSI-RS resources of the inter-cell mobility candidate cell that are configured as at least one QCL source of at least one TCI state, and associated with a trigger quantity greater than other CSI-RS resources of a plurality of CSI-RS resources of the inter-cell mobility candidate cell that are configured as at least one QCL source of at least one TCI state of the inter-cell mobility candidate cell having an overlapping bandwidth part, BWP, with a currently activated BWP of the serving cell in a same frequency of the serving cell.

According to some embodiments of this aspect, the at least one event criterion defines at least one trigger condition that is configured to trigger the measurement report, where the at least one trigger condition comprises one of: the second beam measurement being offset greater than the first beam measurement, the first beam measurement is one of greater than and lower than a threshold, the second beam measurement one of greater than and lower than a threshold, and the first beam measurement is less than a first threshold and the second beam measurement is greater than a second threshold.

According to some embodiments of this aspect, the measurement report is associated with a layer lower than the radio resource control, RRC, layer.

According to some embodiments of this aspect, the measurement report is associated with one of a physical layer and medium access control layer.

According to another aspect of the present disclosure, a network node configured to communicate with a wireless device is provided. The network node is configured to cause transmission of an indication of at least one event criterion, where the at least one event criterion is configured to cause the wireless device to trigger a measurement report in a layer lower than a radio resource control, RRC, layer and is based on at least one of: a first beam measurement of a serving cell, and a second beam measurement associated with an inter-cell mobility candidate cell for a layer lower than the RRC layer. The network node is further configured to receive the measurement report according to the at least one event criterion.

According to some embodiments of this aspect, the network node is further configured to determine inter-cell mobility based at least on the measurement report.

According to some embodiments of this aspect, the measurement report is a channel state information, CSI, report, where the at least one event criterion is indicated in a CSI report configuration.

According to some embodiments of this aspect, the CSI report configuration indicates a reporting configuration of at least one of: at least one inter-cell mobility candidate to be measured for which measurements are compared in the at least one event criterion, and frequency information associated with at least one inter-cell mobility candidate for which measurements are compared in the at least one event criterion.

According to some embodiments of this aspect, at least one of the first beam measurement and the second beam measurement corresponds to a measurement performed on at least one of a reference signal and synchronization signal of the serving cell.

According to some embodiments of this aspect, the first beam measurement corresponds to a measurement of one of a synchronization signal block, SSB, and a channel state information-reference signal, CSI-RS, resource of the serving cell.

According to some embodiments of this aspect, the first beam measurement corresponds to the measurement of the SSB, where the SSB is one of: configured with a quasi-co-location, QCL, of an activated transmission configuration indicator, TCI, state, associated with a measurement quantity greater than measurement quantities of remaining SSBs of a plurality of SSB of the serving cell, associated with a measurement quantity greater than measurement quantities of remaining SSBs of a plurality of SSBs of the serving cell that are configured as at least one QCL source, and associated with a measurement quantity greater than measurement quantities of remaining SSBs of a plurality of SSBs of the serving cell that are configured as at least one QCL source of at least one TCI state of a current serving cell in an activated bandwidth part, BWP.

According to some embodiments of this aspect, the second beam measurement corresponds to a measurement of one of a synchronization signal block, SSB, and a channel state information-reference signal, CSI-RS, resource of the inter-cell mobility candidate cell.

According to some embodiments of this aspect, the second beam measurement corresponds to the measurement of the SSB, where the SSB is one of: configured as a quasi-co-location, QCL, of a transmission configuration indicator, TCI, state of the inter-cell mobility candidate cell, associated with a trigger quantity greater than other SSBs of a plurality of SSBs of the inter-cell mobility candidate cell, associated with a trigger quantity greater than other SSBs of a plurality of SSBs of the inter-cell mobility candidate cell that are configured as at last one QCL source of at least one TCI state, and associated with a trigger quantity greater than other SSBs of a plurality of SSBs of the inter-cell mobility candidate cell that are configured as at least one QCL source of at least one TCI state of the inter-cell mobility candidate cell having an overlapping bandwidth part, BWP, with a currently activated BWP of the serving cell in a same frequency of the serving cell.

According to some embodiments of this aspect, the second beam measurement corresponds to the measurement of the CSI-RS resource, where the CSI-RS resource is one of: associated with a trigger quantity greater than other CSI-RS resources of a plurality of CSI-RS resources of the inter-cell mobility candidate cell, associated with a trigger quantity greater than other CSI-RS resources of a plurality of CSI-RS resources of the inter-cell mobility candidate cell that are configured as at least one QCL source of at least one TCI state, and associated with a trigger quantity greater than other CSI-RS resources of a plurality of CSI-RS resources of the inter-cell mobility candidate cell that are configured as at least one QCL source of at least one TCI state of the inter-cell mobility candidate cell having an overlapping bandwidth part, BWP, with a currently activated BWP of the serving cell in a same frequency of the serving cell.

According to some embodiments of this aspect, the at least one event criterion defines at least one trigger condition that is configured to trigger the measurement report, where the at least one trigger condition comprises one of: the second beam measurement being offset greater than the first beam measurement, the first beam measurement is one of greater than and lower than a threshold, the second beam measurement one of greater than and lower than a threshold, and the first beam measurement is less than a first threshold and the second beam measurement is greater than a second threshold.

According to some embodiments of this aspect, the measurement report is associated with a layer lower than the radio resource control, RRC, layer.

According to some embodiments of this aspect, the measurement report is associated with one of a physical layer and medium access control layer.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a schematic diagram of an example network architecture illustrating a communication system connected via an intermediate network to a host computer according to the principles in the present disclosure;

FIG. 2 is a block diagram of a host computer communicating via a network node with a wireless device over an at least partially wireless connection according to some embodiments of the present disclosure;

FIG. 3 is a flowchart illustrating example methods implemented in a communication system including a host computer, a network node and a wireless device for executing a client application at a wireless device according to some embodiments of the present disclosure;

FIG. 4 is a flowchart illustrating example methods implemented in a communication system including a host computer, a network node and a wireless device for receiving user data at a wireless device according to some embodiments of the present disclosure;

FIG. 5 is a flowchart illustrating example methods implemented in a communication system including a host computer, a network node and a wireless device for receiving user data from the wireless device at a host computer according to some embodiments of the present disclosure;

FIG. 6 is a flowchart illustrating example methods implemented in a communication system including a host computer, a network node and a wireless device for receiving user data at a host computer according to some embodiments of the present disclosure;

FIG. 7 is a flowchart of an example process in a network node according to some embodiments of the present disclosure;

FIG. 8 is a flowchart of another example process in a network node according to some embodiments of the present disclosure;

FIG. 9 is a flowchart of an example process in a wireless device according to some embodiments of the present disclosure; and

FIG. 10 is a flowchart of another example process in a wireless device according to some embodiments of the present disclosure.

### DETAILED DESCRIPTION

As described, a WID has been created with the goal of specifying mechanisms and procedures of L1/L2 based inter-cell mobility for mobility latency reduction related to:
Configuration and maintenance for multiple candidate cells to allow fast application of configurations for candidate cells [radio access network 2 (RAN2), RAN3]
Dynamic switch mechanism among candidate serving cells (including SpCell and SCell) for the potential applicable scenarios based on L1/L2 signalling [RAN2, RAN1]
L1 enhancements for inter-cell beam management, including L1 measurement and reporting, and beam indication [RAN1, RAN2]
   Note 1: Early RAN2 involvement is necessary, including the possibility of further clarifying the interaction between this bullet with the previous bullet
Timing Advance management [RAN1, RAN2]
CU-DU interface signaling to support L1/L2 mobility, if needed [RAN3]
Note 2: frequency range 2 (FR2) specific enhancements are not precluded, if any.
Note 3: The procedure of L1/L2 based inter-cell mobility are applicable to the following scenarios:
   Standalone, CA and NR-direct connectivity (DC) case with serving cell change within one CG
   Intra-distributed unit (DU) case and intra-central unit (CU) inter-DU case (applicable for Standalone and CA: no new RAN interfaces are expected)
   Both intra-frequency and inter-frequency
   Both FR1 and FR2

### Source and Target Cells May be Synchronized or Non-Synchronized

As indicated in the WID, L1 enhancements for inter-cell beam management, including L1 measurement and reporting need to be investigated. Current CSI measurement reporting framework only allows the wireless device to trigger CSI reports in the time domain to be periodic, aperiodic or semi-persistent.

However, periodic reports are known to create a high amount of overhead in the Uplink as CSI reports are transmitted even when the current beam serving the wireless device is still the best beam, e.g., if the SSB and/or CSI-RS configured as QCL source of the current active TCI state has the strongest Layer 1 received signal received power (RSRP) and/or received signal receive quality (RSRQ) and/or signal to interference plus noise ratio (SINR).

Aperiodic and semi-persistent reports mitigate the UL overhead. On the other hand, these put the burden on the network node 16 to request the wireless device to report CSI measurements when it is needed. This also assumes the radio conditions in the current DL beam are at least good enough for the wireless device to receive the downlink (DL) signaling to request the CSI measurements, which may lead to risks of failure.

In addition to that, the wireless device may be configured with multiple L1/L2 inter-cell mobility candidate cells that makes the whole solution based on periodic and aperiodic reports more difficult, as the wireless device may not be explicitly configured with the beams/SSBs and/or CSI-RSs of the L1/L2 inter-cell mobility candidate cells.

One or more embodiments described herein solve one or more problems with existing systema and/or proposed standards by, for example, triggering by the wireless device of the transmission of an event-triggered lower layer measurement reports to assist L1/L2 inter-cell mobility based on a first beam measurement and/or a second beam measurement where the first measurement is of a serving cell (e.g., PCell) and the second measurement is of a L1/L2 inter-cell mobility candidate cell. In one or more embodiments, the event is the fulfillment of the one or more trigger condition(s), transmitting a lower layer measurement report to the network node including at least the one or more of: i) the first beam measurement; ii) the second beam measurement. Hence, one or more embodiments described herein relate to L1/L2 inter-cell mobility.

Before describing in detail example embodiments, it is noted that the embodiments reside primarily in combinations of apparatus components and processing steps related to event based reports associated with Layer 1/Layer 2 (L1/L2) inter-cell mobility. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MIDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IoT) device, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

L1 as used herein may refer to the physical (PHY) layer and L2 as used herein may refer to the medium access control (MAC) layer. The term “L1/L2 based inter-cell mobility” may be used interchangeably herein with L1/L2 mobility, L1-mobility, L1 based mobility, L1/L2-centric inter-cell mobility, L1/L2 mobility or L1/L2 inter-cell mobility. The one principle in “L1/L2 based inter-cell mobility” is that the wireless receives lower layer signaling from the network node indicating to the wireless device a change of its serving cell (e.g., change of PCell, from a source to a target PCell), where the lower layer signaling corresponds to a message/signaling of a lower layer protocol. For example, a lower layer may correspond to a layer lower than the RRC layer such as layer 1 or layer 2. Another aspect in L1/L2 inter-cell mobility is that in multi-beam scenario, a cell can be associated to multiple SSBs, and during a half-frame, different SSBs may be transmitted in different spatial directions (i.e., using different beams, spanning the coverage area of a cell). Similar reasoning may be applicable to CSI-RS resources, which may also be transmitted in different spatial directions. Hence, in L1/L2 inter-cell mobility, the reception of a lower layer signaling indicates for the wireless device to change from one beam in the serving cell, to another beam in a neighbor cell (which is a configured candidate cell, also called a L1/L2 inter-cell mobility candidate), and by that changing serving cell.

A lower layer protocol refers to a lower layer protocol in the air interface protocol stack compared to RRC protocol, e.g., Medium Access Control (MAC) is considered a lower layer protocol as it is “below” RRC in the air interface protocol stack, and in this case the lower layer signaling/message may correspond to a MAC Control Element (MAC CE), e.g., layer 2. Another example of lower layer protocol is the Layer 1 (or Physical Layer, L1), and in this case a lower layer signaling/message may correspond to a Downlink Control Information (DCI). Signaling information in a protocol layer lower than RRC reduces the processing time and, consequently, reduces the interruption time during mobility; in addition, it may also increase the mobility robustness as the network may respond to faster changes in the channel conditions.

The term “L1/L2 inter-cell mobility candidate cell” refers to a cell the wireless device is configured with when configured with L1/L2 inter-cell mobility. That is a cell the wireless device can move to in a L1/L2 inter-cell mobility procedure, upon reception of the lower layer signaling as described herein. These cells may also be called candidate cells, candidates, mobility candidates, non-serving cells, additional cells, L1/L2 inter-cell mobility candidates, target candidate cells, etc. This is a cell the wireless device may perform lower layer measurements on (e.g., CSI measurements) as described herein, so that the wireless device reports these measurements when one or more condition(s) are fulfilled (i.e., even-triggered) and network may take educated decision on which beam (e.g., TCI state) and/or cell the wireless device 22 is to be switched to. A L1/L2 inter-cell mobility candidate cell may be a candidate to be a target PCell or PSCell, or an SCell of a cell group (e.g. MCG SCell), so it may also be referred to as a target candidate cell. In that sense, when the description herein refers to a resource configuration to indicate SSs and/or RSs for the wireless device to measure for CSI for reporting, the description may be referring to SSs and/or RSs of a candidate SCell of the MCG, a candidate SCell of the SCG, a candidate PSCell and/or a candidate PCell.

As used herein, a CSI resource (or resource set) includes one or more CSI resources to be measured by the wireless device to be used as input to the events for lower layer reporting (e.g., CSI reporting), where a CSI resource (or resource set) may be associated to a serving cell and/or to a L1/L2 inter-cell mobility candidate cell, where a resource may be, for example, one or more SSs and/or one or more RSs. A CSI resource may be determined by the wireless device, for example, in one or more of the following ways:
i) a CSI resource or resource set is configured in the serving cell configuration, i.e., the wireless device receives a CSI resource set configuration, where a resource or resource set is associated to the serving cell and/or to another cell (which may be a L1/L2 inter-cell mobility candidate cell); and/or
ii) a CSI resource or resource set of the serving cell is within the serving cell configuration the wireless device receives (e.g., SSBs and/or CSI-RSs indicated as resources to be measured, or configured as QCL source for TCI states of that serving cell), and in the L1/L2 inter-cell mobility candidate configuration (to be applied and/or switched to upon L1/L2 inter-cell mobility execution) for a L1/L2 inter-cell mobility candidate, e.g., SSBs and/or CSI-RSs configured as QCL source for TCI states of the target candidate.

A “measurement” may refer to a measurement to be used as input to the events/trigger conditions and to be possibly included in a lower layer measurement report (e.g., CSI measurement to assist L1/L2 inter-cell mobility execution) and is a measurement based on which the wireless device derives information to include in a CSI report, to at least assist the network node to determine to perform L1/L2 inter-cell mobility. A lower layer measurement (e.g., a CSI measurement in this context) is different from a RRM measurement reported on an RRC MeasurementReport message, as defined in 3GPP TS 38.331. An RRM measurement is configured by an RRC measurement configuration (IE MeasConfig in the first ASN.1 level in the RRCReconfiguration message), and is Layer 3 filtered and used as input to trigger an RRC Measurement Report (which is an RRC message), and once reported, is typically used by the network node (e.g., the CU) to determine whether the wireless device needs to be handed over to another cell or not, with an RRC procedure called Reconfiguration with Sync procedure.

In the context of one or more embodiments described herein, a lower layer measurement (e.g., CSI measurement) may be configured by a lower layer measurement configuration (e.g., CSI measurement configuration, CSI-MeasConfig-L1-L2-Mobility), and is not necessarily OSI Layer 3 (Layer 3 is also known as the “network layer”) filtered by the wireless device, and may not be used as input to trigger an RRC Measurement Report (which is an RRC message) but instead is used as input to derive information that is included in a lower layer measurement report, which is different than an RRC Measurement report, as a lower layer measurement report (e.g., CSI report, beam report) is not an RRC message, but a message in a layer lower than RRC in the protocol stack, e.g., Physical Layer/Layer 1 (L1), such as a CSI report over PUCCH and/or PUSCH similar to the one(s) defined in, for example, 3GPP TS 38.214, but possibly including information of L1/L2 inter-cell mobility candidate cells, and/or a MAC CE. Once a lower layer measurement report (e.g., CSI report) is reported, it is typically used by the lower layers at the network node side, such as the baseband unit and/or the gNodeB-Distributed Unit (DU), to determine whether the wireless device needs to be switched to a beam (and/or SSB, TCI state, QCL source) of a candidate cell, in a L1/L2 inter-cell mobility execution procedure.

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

In some embodiments, the general description elements in the form of “one of A and B” corresponds to A or B. In some embodiments, at least one of A and B corresponds to A, B or AB, or to one or more of A and B. In some embodiments, at least one of A, B and C corresponds to one or more of A, B and C, and/or A, B, C or a combination thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments provide event based reports associated with Layer 1/Layer 2 (L1/L2) inter-cell mobility.

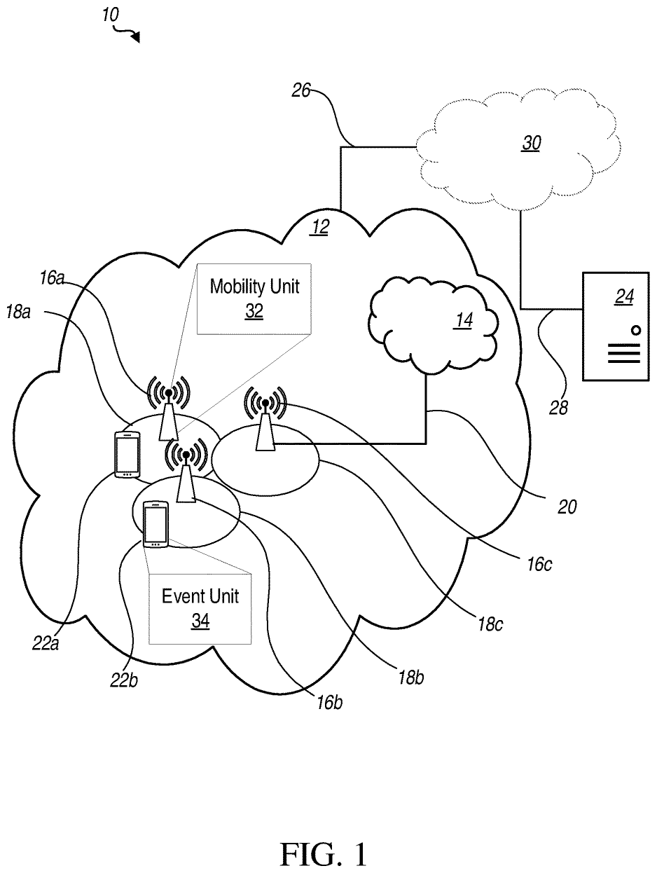

Referring now to the drawing figures, in which like elements are referred to by like reference numerals, there is shown in FIG. 1 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 1 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include a mobility unit 32 which is configured to perform one or more network node 16 functions described herein such as with respect to, for example, event based reports associated with L1/L2 inter-cell mobility. A wireless device 22 is configured to include an event unit 34 which is configured to perform one or more wireless device 22 functions described herein such as with respect to, for example, event based reports associated with L1/L2 inter-cell mobility.

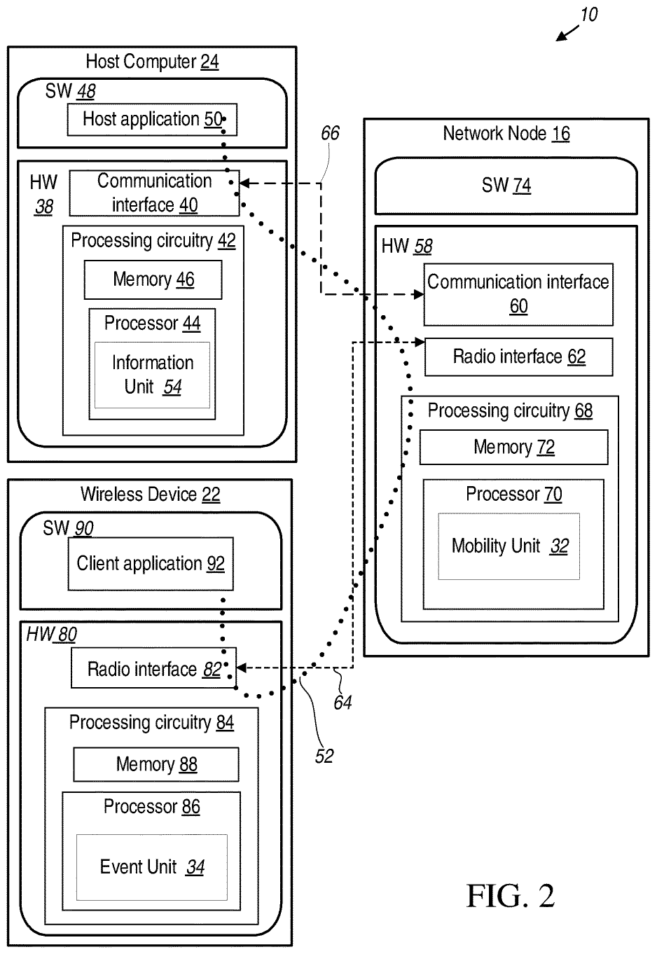

Example implementations, in accordance with an embodiment, of the WD 22, network node 16 and host computer 24 discussed in the preceding paragraphs will now be described with reference to FIG. 2. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22. The processing circuitry 42 of the host computer 24 may include an information unit 54 configured to enable the service provider to determine, analyze, store, transmit, receive, relay, forward, etc. information related to, for example, event based reports associated with L1/L2 inter-cell mobility.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include mobility unit 32 configured to perform one or more network node 16 functions as described herein such as with respect to, for example, event based reports associated with L1/L2 inter-cell mobility.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include an event unit 34 configured to perform one or more wireless device 22 functions as described herein such as with respect to, for example, event based reports associated with L1/L2 inter-cell mobility.

In some embodiments, the inner workings of the network node 16, WD 22, and host computer 24 may be as shown in FIG. 2 and independently, the surrounding network topology may be that of FIG. 1.

In FIG. 2, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 1 and 2 show various “units” such as mobility unit 32, and event unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

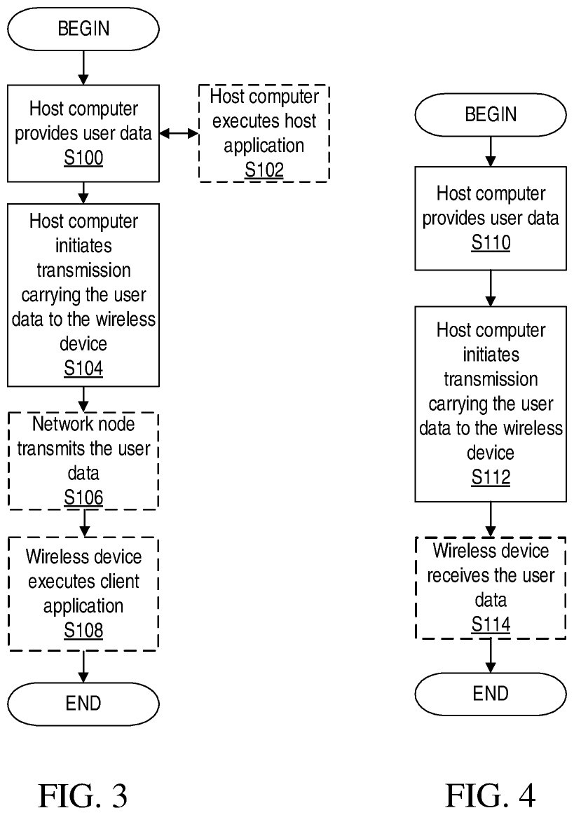

FIG. 3 is a flowchart illustrating an example method implemented in a communication system, such as, for example, the communication system of FIGS. 1 and 2, in accordance with one embodiment. The communication system may include a host computer 24, a network node 16 and a WD 22, which may be those described with reference to FIG. 2. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 4 is a flowchart illustrating an example method implemented in a communication system, such as, for example, the communication system of FIG. 1, in accordance with one embodiment. The communication system may include a host computer 24, a network node 16 and a WD 22, which may be those described with reference to FIGS. 1 and 2. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

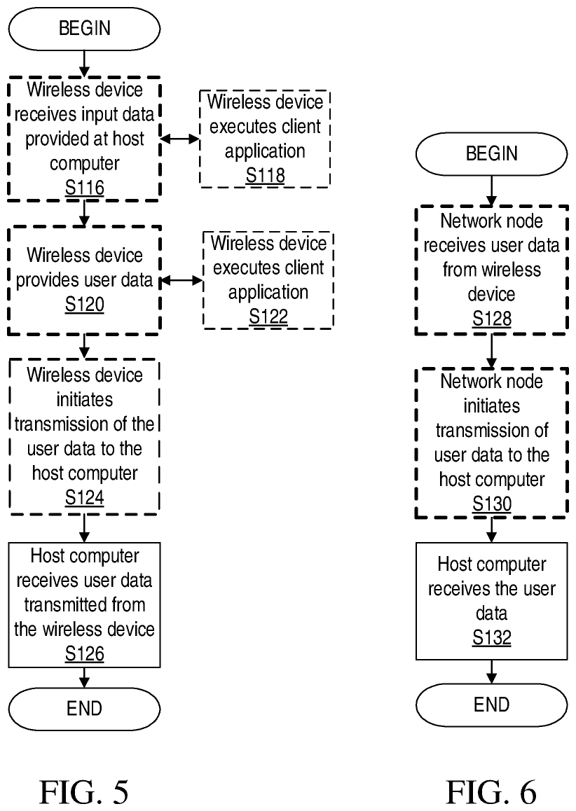

FIG. 5 is a flowchart illustrating an example method implemented in a communication system, such as, for example, the communication system of FIG. 1, in accordance with one embodiment. The communication system may include a host computer 24, a network node 16 and a WD 22, which may be those described with reference to FIGS. 1 and 2. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118).

Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 6 is a flowchart illustrating an example method implemented in a communication system, such as, for example, the communication system of FIG. 1, in accordance with one embodiment. The communication system may include a host computer 24, a network node 16 and a WD 22, which may be those described with reference to FIGS. 1 and 2. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

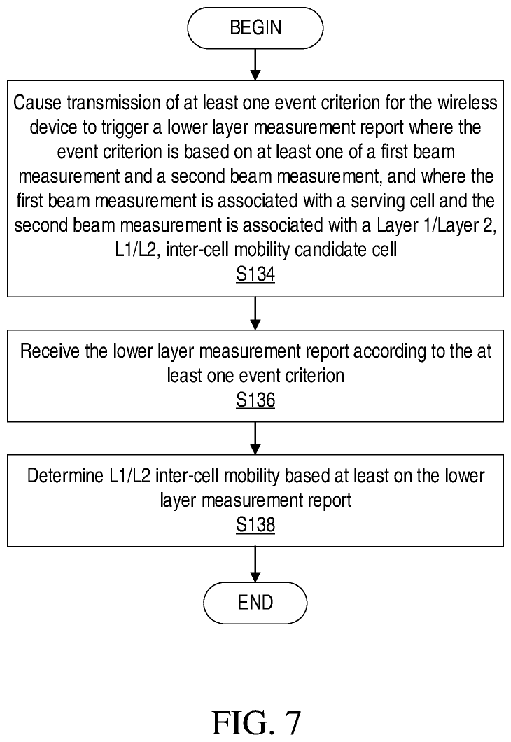

FIG. 7 is a flowchart of an example process in a network node 16 according to one or more embodiments of the present disclosure. One or more blocks described herein may be performed by one or more elements of network node 16 such as by one or more of processing circuitry 68 (including the mobility unit 32), processor 70, radio interface 62 and/or communication interface 60. Network node 16 is configured to cause (Block S134) transmission of at least one event criterion for the wireless device 22 to trigger a lower layer measurement report where the event criterion is based on at least one of a first beam measurement and a second beam measurement, and where the first beam measurement is associated with a serving cell and the second beam measurement is associated with a Layer 1/Layer 2, L1/L2, inter-cell mobility candidate cell, as described herein. Network node 16 is configured to receive (Block S136) the lower layer measurement report according to the at least one event criterion, as described herein. Network node 16 is configured to determine (Block S138) L1/L2 inter-cell mobility based at least on the lower layer measurement report, as described herein.

According to one or more embodiments, the at least one event criterion is transmitted via radio resource control, RRC, signaling. According to one or more embodiments, the lower layer measurement report includes at least one of the first beam measurement and the second beam measurement. According to one or more embodiments, the at least one event criterion is not met when a current beam serving the wireless device has a stronger Layer 1 RSRP, RSRQ and/or SINR than a remaining plurality of beams.

According to one or more embodiments, the at least one event criterion is met when the second beam measurement is offset greater than the first beam measurement. According to one or more embodiments, the at least one event criterion is met when at least one of: the first beam measurement is one of greater than and less than a first threshold, and the second beam measurement is one of greater than and less than a second threshold. According to one or more embodiments, the lower layer corresponds to a layer that is lower than the radio resource control, RRC, layer in a protocol stack.

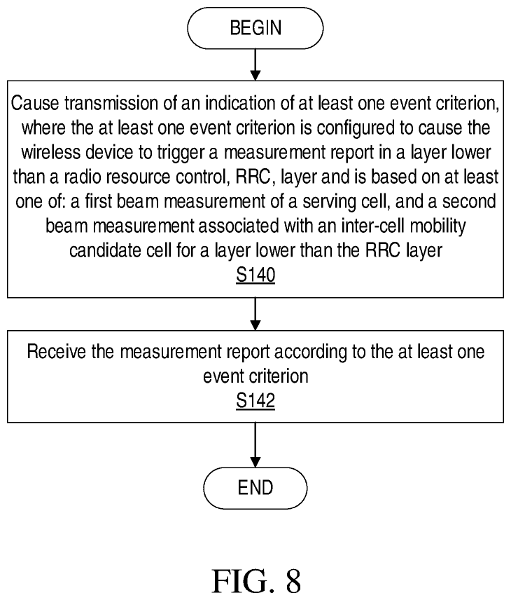

FIG. 8 is a flowchart of another example process in a network node 16 according to one or more embodiments of the present disclosure. One or more blocks described herein may be performed by one or more elements of network node 16 such as by one or more of processing circuitry 68 (including the mobility unit 32), processor 70, radio interface 62 and/or communication interface 60. Network node 16 is configured to cause (Block S140) cause transmission of an indication of at least one event criterion, where the at least one event criterion is configured to cause the wireless device 22 to trigger a measurement report in a layer lower than a radio resource control, RRC, layer and is based on at least one of a first beam measurement of a serving cell, and a second beam measurement associated with an inter-cell mobility candidate cell for a layer lower than the RRC layer, as described herein. Network node 16 is configured to receive (Block S142) the measurement report according to the at least one event criterion, as described herein.

According to one or more embodiments, the network node 16 is further configured to determine inter-cell mobility based at least on the measurement report.

According to one or more embodiments, the measurement report is a channel state information, CSI, report, and the at least one event criterion is indicated in a CSI report configuration.

According to one or more embodiments, the CSI report configuration indicates a reporting configuration of at least one of at least one inter-cell mobility candidate cell to be measured for which measurements are compared in the at least one event criterion, and frequency information associated with at least one inter-cell mobility candidate cell for which measurements are compared in the at least one event criterion.

According to one or more embodiments, at least one of the first beam measurement and the second beam measurement corresponds to a measurement performed on at least one of a reference signal and synchronization signal of the serving cell.

According to one or more embodiments, the first beam measurement corresponds to a measurement of one of a synchronization signal block, SSB, and a channel state information-reference signal, CSI-RS, resource of the serving cell.

According to one or more embodiments, the first beam measurement corresponds to the measurement of the SSB, where the SSB is one of configured with a quasi-co-location, QCL, of an activated transmission configuration indicator, TCI, state, associated with a measurement quantity greater than measurement quantities of remaining SSBs of a plurality of SSB of the serving cell, associated with a measurement quantity greater than measurement quantities of remaining SSBs of a plurality of SSBs of the serving cell that are configured as at least one QCL source, and associated with a measurement quantity greater than measurement quantities of remaining SSBs of a plurality of SSBs of the serving cell that are configured as at least one QCL source of at least one TCI state of a current serving cell in an activated bandwidth part, BWP.

According to one or more embodiments, the second beam measurement corresponds to a measurement of one of a synchronization signal block, SSB, and a channel state information-reference signal, CSI-RS, resource of the inter-cell mobility candidate cell.

According to one or more embodiments, the second beam measurement corresponds to the measurement of the SSB, the SSB is one of configured as a quasi-co-location, QCL, of a transmission configuration indicator, TCI, state of the inter-cell mobility candidate cell, associated with a trigger quantity greater than other SSBs of a plurality of SSBs of the inter-cell mobility candidate cell, associated with a trigger quantity greater than other SSBs of a plurality of SSBs of the inter-cell mobility candidate cell that are configured as at last one QCL source of at least one TCI state, and associated with a trigger quantity greater than other SSBs of a plurality of SSBs of the inter-cell mobility candidate cell that are configured as at least one QCL source of at least one TCI state of the inter-cell mobility candidate cell having an overlapping bandwidth part, BWP, with a currently activated BWP of the serving cell in a same frequency of the serving cell.

According to one or more embodiments, the second beam measurement corresponds to the measurement of the CSI-RS resource, the CSI-RS resource is one of: associated with a trigger quantity greater than other CSI-RS resources of a plurality of CSI-RS resources of the inter-cell mobility candidate cell, associated with a trigger quantity greater than other CSI-RS resources of a plurality of CSI-RS resources of the inter-cell mobility candidate cell that are configured as at least one QCL source of at least one TCI state, and associated with a trigger quantity greater than other CSI-RS resources of a plurality of CSI-RS resources of the inter-cell mobility candidate cell that are configured as at least one QCL source of at least one TCI state of the inter-cell mobility candidate cell having an overlapping bandwidth part, BWP, with a currently activated BWP of the serving cell in a same frequency of the serving cell.

According to one or more embodiments, the at least one event criterion defines at least one trigger condition that is configured to trigger the measurement report, the at least one trigger condition comprises one of the second beam measurement being offset greater than the first beam measurement, the first beam measurement is one of greater than and lower than a threshold, the second beam measurement one of greater than and lower than a threshold, and the first beam measurement is less than a first threshold and the second beam measurement is greater than a second threshold.

According to one or more embodiments, the measurement report is associated with a layer lower than the radio resource control, RRC, layer.

According to one or more embodiments, the measurement report is associated with one of a physical layer and medium access control layer.

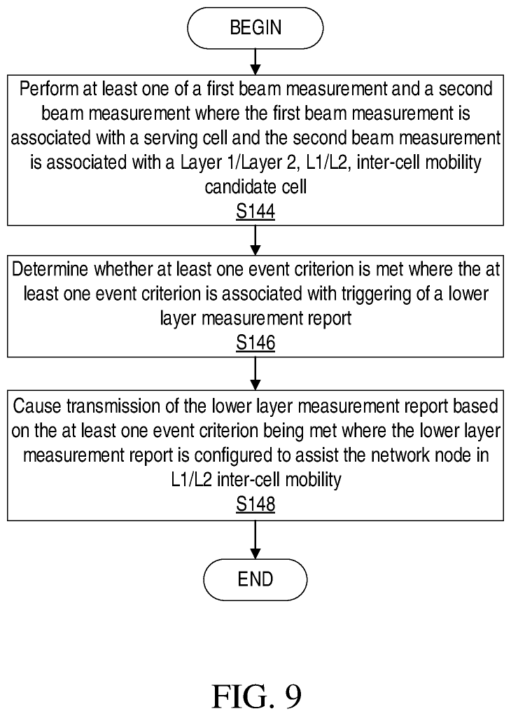

FIG. 9 is a flowchart of an example process in a wireless device 22 according to some embodiments of the present disclosure. One or more blocks described herein may be performed by one or more elements of wireless device 22 such as by one or more of processing circuitry 84 (including the event unit 34), processor 86, radio interface 82 and/or communication interface 60. Wireless device 22 is configured to perform (Block S144) at least one of a first beam measurement and a second beam measurement where the first beam measurement is associated with a serving cell and the second beam measurement is associated with a Layer 1/Layer 2, L1/L2, inter-cell mobility candidate cell, as described herein. Wireless device 22 is configured to determine (Block S146) whether at least one event criterion is met where the at least one event criterion is associated with triggering of a lower layer measurement report, as described herein. Wireless device 22 is configured to cause (Block S148) transmission of the lower layer measurement report based on the at least one event criterion being met where the lower layer measurement report is configured to assist the network node in L1/L2 inter-cell mobility, as described herein.

According to one or more embodiments, the processing circuitry 84 is further configured to receive the at least one event criterion via radio resource control, RRC, signaling. According to one or more embodiments, the lower layer measurement report includes at least one of the first beam measurement and the second beam measurement. According to one or more embodiments, the at least one event criterion is not met when a current beam serving the wireless device 22 has a stronger Layer 1 RSRP, RSRQ and/or SINR than a remaining plurality of beams.

According to one or more embodiments, the at least one event criterion is met when the second beam measurement is offset greater than the first beam measurement. According to one or more embodiments, the at least one event criterion is met when at least one of: the first beam measurement is one of greater than and less than a first threshold, and the second beam measurement is one of greater than and less than a second threshold. According to one or more embodiments, the lower layer corresponds to a layer that is lower than the radio resource control, RRC, layer in a protocol stack.

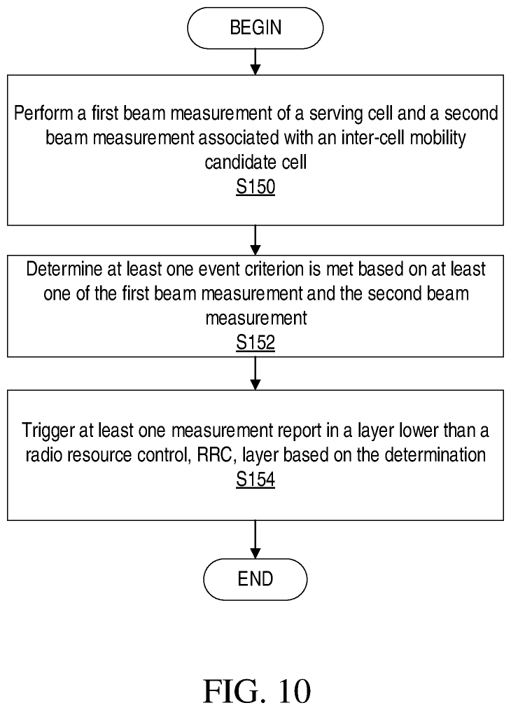

FIG. 10 is a flowchart of an example process in a wireless device 22 according to some embodiments of the present disclosure. One or more blocks described herein may be performed by one or more elements of wireless device 22 such as by one or more of processing circuitry 84 (including the event unit 34), processor 86, radio interface 82 and/or communication interface 60. Wireless device 22 is configured to perform (Block S150) a first beam measurement of a serving cell and a second beam measurement associated with an inter-cell mobility candidate cell, as described herein. Wireless device 22 is configured to determine (Block S152) at least one event criterion is met based on at least one of the first beam measurement and the second beam measurement, as described herein. Wireless device 22 is configured to trigger (Block S154) at least one measurement report in a layer lower than a radio resource control, RRC, layer based on the determination.

According to one or more embodiments, the measurement report is a channel state information, CSI, report, and the wireless device is further configured to receive a CSI report configuration indicating the at least one event criterion.

According to one or more embodiments, the CSI report configuration indicates a reporting configuration of at least one of: at least one inter-cell mobility candidate cell to be measured for which measurements are compared in the at least one event criterion, and frequency information associated with at least one inter-cell mobility candidate cell for which measurements are compared in the at least one event criterion.

According to one or more embodiments, at least one of the first beam measurement and the second beam measurement corresponds to a measurement performed on at least one of a reference signal and synchronization signal of the serving cell.

According to one or more embodiments, the first beam measurement corresponds to a measurement of one of a synchronization signal block, SSB, and a channel state information-reference signal, CSI-RS, resource of the serving cell.

According to one or more embodiments, the first beam measurement corresponds to the measurement of the SSB, where the SSB is one of: configured with a quasi-co-location, QCL, of an activated transmission configuration indicator, TCI, state, associated with a measurement quantity greater than measurement quantities of remaining SSBs of a plurality of SSB of the serving cell, associated with a measurement quantity greater than measurement quantities of remaining SSBs of a plurality of SSBs of the serving cell that are configured as at least one QCL source, and associated with a measurement quantity greater than measurement quantities of remaining SSBs of a plurality of SSBs of the serving cell that are configured as at least one QCL source of at least one TCI state of a current serving cell in an activated bandwidth part, BWP.

According to one or more embodiments, the second beam measurement corresponds to a measurement of one of a synchronization signal block, SSB, and a channel state information-reference signal, CSI-RS, resource of the inter-cell mobility candidate cell.

According to one or more embodiments, the second beam measurement corresponds to the measurement of the SSB, where the SSB is one of: configured as a quasi-co-location, QCL, of a transmission configuration indicator, TCI, state of the inter-cell mobility candidate cell, associated with a measurement quantity greater than other SSBs of a plurality of SSBs of the inter-cell mobility candidate cell, associated with a measurement quantity greater than other SSBs of a plurality of SSBs of the inter-cell mobility candidate cell that are configured as at least one QCL source of at least one TCI state, and associated with a measurement quantity greater than other SSBs of a plurality of SSBs of the inter-cell mobility candidate cell that are configured as at least one QCL source of at least one TCI state of the inter-cell mobility candidate cell having an overlapping bandwidth part, BWP, with an activated BWP of the serving cell in a same frequency of the serving cell.

According to one or more embodiments, the second beam measurement corresponds to the measurement of the CSI-RS resource, where the CSI-RS resource is one of: associated with a measurement quantity greater than other CSI-RS resources of a plurality of CSI-RS resources of the inter-cell mobility candidate cell, associated with a measurement quantity greater than other CSI-RS resources of a plurality of CSI-RS resources of the inter-cell mobility candidate cell that are configured as at least one QCL source of at least one TCI state, and associated with a measurement quantity greater than other CSI-RS resources of a plurality of CSI-RS resources of the inter-cell mobility candidate cell that are configured as at least one QCL source of at least one TCI state of the inter-cell mobility candidate cell having an overlapping bandwidth part, BWP, with an activated BWP of the serving cell in a same frequency of the serving cell.

According to one or more embodiments, the at least one event criterion defines at least one trigger condition that is configured to trigger the measurement report, where the at least one trigger condition comprises one of the second beam measurement being offset greater than the first beam measurement, the first beam measurement is one of greater than and lower than a threshold, the second beam measurement one of greater than and lower than a threshold, and the first beam measurement is less than a first threshold and the second beam measurement is greater than a second threshold.

According to one or more embodiments, the measurement report is associated with a layer lower than the radio resource control, RRC, layer.

According to one or more embodiments, the measurement report is associated with one of a physical layer and medium access control layer.

Having described the general process flow of arrangements of the disclosure and having provided examples of hardware and software arrangements for implementing the processes and functions of the disclosure, the sections below provide details and examples of arrangements for event based reports associated with L1/L2 inter-cell mobility.

Some embodiments provide for event based reports associated with L1/L2 inter-cell mobility. One or more wireless device 22 functions described below may be performed by one or more of processing circuitry 84, processor 86, event unit 34, etc. One or more network node 16 functions described below may be performed by one or more of processing circuitry 68, processor 70, mobility unit 32, etc.

### Examples of Configuration for a Lower Layer Measurement Report

In one or more embodiments, the configuration for a lower layer measurement report (also referred to as “report”) may include a reporting configuration, such as a CSI-ReportConfig IE, including one or more parameters and/or fields and/or IE(s) indicating one or more of:
The time-domain behavior for the wireless device 22 to transmit a lower layer measurement report, such as an indication the lower layer measurement report is to be transmitted in an event-triggered manner. In other words, indicating that the wireless device 22 should transmit the lower layer measurement report upon the fulfillment of one or more trigger condition(s), e.g., as described herein.
One or more CSI resources and/or resource sets (e.g., SSB indexes and/or CSI-RS resource identifiers) associated to i) a serving cell for performing first beam measurements; ii) a neighbor cell in the same frequency as the serving cell; iii) a neighbor cell in a neighbor frequency, i.e., not a serving frequency; iii) a L1/L2 inter-cell mobility candidate cell, i.e., a cell configured at the wireless device 22 as a candidate for L1/L2 inter-cell mobility.
   In some embodiments, the wireless device 22 performs beam measurements on the serving cell, e.g., SSB measurements, CSI-RS measurements, at least for the RS configured as QCL source of the currently activated TCI state.
   In some embodiments, the wireless device 22 is indicated for a given reporting configuration at least one L1/L2 inter-cell mobility candidate cell which is to be measured and/or considered as applicable, i.e., for which measurements on one or more of its beams may trigger a lower layer measurement report. The wireless device 22 may consider any beam in that L1/L2 inter-cell mobility candidate cell as a candidate for triggering a lower layer measurement report, e.g., measurements on any beam of that cell may be compared with the quality of the serving beam (i.e., beam in which data and control channels are being transmitted in the serving cell).
   In some embodiments, the wireless device 22 is indicated in a reporting configuration a frequency information (e.g., SSB frequency, CSI-RS frequency, carrier frequency, ARFCN, point A frequency, absolute frequency, relative frequency) associated to at least one L1/L2 inter-cell mobility candidate cell to be measured and/or considered as applicable, i.e., for which measurements on one or more of its beams may trigger a lower layer measurement report. In other words, the wireless device 22 may search for candidate cells in that indicated frequency, to perform measurements to be used as input to the events for triggering lower layer measurement reports. In one option, the frequency indication may be a measurement object identifier, associated to a frequency configured in an RRC Measurement configuration (e.g., IE MeasConfig).
   In one embodiment, the wireless device 22 is indicated in a reporting configuration which beams, also called candidate beams, (e.g., beam ID 1, beam ID 2, . . . , beam ID N) of a L1/L2 inter-cell mobility candidate cell are to be measured and used as input to the event(s) which may trigger lower layer measurement reports.
      In some embodiments, these candidate beams are provided as part of the serving cell configuration in which the reporting configuration is included.
      In some embodiments, these candidate beams are provided as part of the configuration of the L1/L2 inter-cell mobility candidate cell, e.g., as part of the CSI resource configuration, or as the beams configured for transmitting control and data channels of that L1/L2 inter-cell mobility candidate cell.
   In some embodiments, the wireless device 22 is indicated in a reporting configuration which RSs (e.g., SSB ID 1, SSB ID 2, . . . , SSB ID N) of a L1/L2 inter-cell mobility candidate cell are to be measured and used as input to the event(s) which may trigger lower layer measurement reports.
      In some embodiments, these SSBs (and/or CSI-RS) are provided as part of the serving cell configuration in which the reporting configuration is included.
      In some embodiments, these candidate SSBs are provided as part of the configuration of the L1/L2 inter-cell mobility candidate cell, e.g., as part of the CSI resource configuration, or as the SSBs configured as QCL source of the configured TCI state(s) of that L1/L2 inter-cell mobility candidate cell.
In the case of event-triggered reporting, one or more associated configuration(s) such as:
   An event configuration, configuring one or more trigger condition(s) (e.g., event criterion/criteria) based on a first beam measurement and/or a second beam measurement. Examples of trigger conditions/event configuration are described herein, e.g., second measurement an offset better than the first measurement.
   A trigger quantity, indicating which measurement the wireless device 22 performs as used as an input to the trigger condition associated to the report, e.g., RSRP, RSRQ, SINR, RSSI, etc.
   A reference signal type, such as SSB or CSI-RS.
   Time to trigger
A list of L1/L2 inter-cell mobility candidate cells for which this lower layer measurement report applies. This implies that even if the network node 16 is configured with a total of “N” L1/L2 inter-cell mobility candidate cells, this event-triggered lower layer measurement reporting configuration may only apply to “K” L1/L2 inter-cell mobility candidate cells, where K<N. This will reduce the amount of CSI measurement that the wireless device 22 needs to perform and also the amount of possible measurement reporting.

### Examples of First and Second Beam Measurement(s)

In one or more embodiments, the first beam measurement (also referred to as first measurement) is a measurement of a serving cell (e.g., PCell, PSCell, SCell of the MCG, SCell of the SCG) or a cell the wireless device 22 is configured with and which is currently serving the wireless device 22 with data and/or control channels. The measurement may correspond to a measurement (e.g., an RSRP, RSRQ, SINR, RSSI, any other quality measurement, received signal power measurement value) performed on a reference signal (RS) and/or synchronization signal (SS) of that serving cell, such as an SSB and/or CSI-RS of the serving cell, where the RS and/or SS may the transmitted in a spatial direction (also referred to as a beam), so that the first measurement may be referred to as a beam measurement. That measurement may reflect the quality of the beam serving the wireless device 22, e.g., correlated to the quality of ongoing transmissions of control and data channels to the wireless device 22. That may be referred to as a reference beam, as it is considered as the beam to be compared with candidate beams and/or measurement thresholds (depending which event is configured).
Example 1a) In some embodiments, the first beam measurement is a measurement on the SSB of the serving cell (e.g., SS-RSRP, SS-RSRQ, SS-SINR, L1 RSRP of an SSB, L1 RSRQ or SINR of an SSB) which is configured as Quasi-Co-Location (QCL) of an activated TCI state.
Example 1b) In some embodiments, the first measurement is a measurement on the SSB of the serving cell whose trigger quantity (e.g., RSRP, RSRQ, SINR, RSSI) is the strongest. For example, the wireless device 22 performs measurements on or more SSBs of the serving cell according to the trigger quantity (e.g., if trigger quantity is RSRP, the wireless device 22 obtains the SS-RSRP(1) for SSB index=1, SS-RSRP(2) for SSB index=2, . . . , SS-RSRP(k), . . . , SS-RSRP(K) for SSB index=K, and selects the SSB whose SS-RSRP is the strongest e.g. SS-RSRP(k)*, with SSB index=k*. The first measurement is the SS-RSRP(k)*.
Example 1c) In some embodiments, the first measurement is a measurement on the SSB of the serving cell (among the SSBs configured as QCL source(s) of TCI states of the current serving cell), e.g., whose trigger quantity (e.g. RSRP, RSRQ, SINR, RSSI) is the strongest. For example, the wireless device 22 performs measurements on or more SSBs of the serving cell (among the SSBs configured as QCL source(s) of TCI states of the current serving cell. In other words, SSBs of candidate beams (e.g., configured as QCL source type D) are considered, but not all SSBs of that serving cell.
Example 1d) In some embodiments, the first measurement is a measurement on the SSB of the serving cell (among the SSBs configured as QCL source(s) of TCI states of the current serving cell and excluding the SSB which is QCL of an activated TCI state), e.g., whose trigger quantity (e.g., RSRP, RSRQ, SINR, RSSI) is the strongest. For example, the wireless device 22 performs measurements on or more SSBs of the serving cell (among the SSBs configured as QCL source(s) of TCI states of the current serving cell, excluding the SSB which is QCL of an activated TCI state. In other words, only SSBs of candidate beams (e.g., configured as QCL source type D) are considered of that serving cell.
Example 1e) In some embodiments, the first measurement is a measurement on the SSB of the serving cell among the SSBs configured as QCL source(s) of TCI states of the current serving cell in the currently activated Bandwidth Part (BWP), e.g., whose trigger quantity (e.g., RSRP, RSRQ, SINR, RSSI) is the strongest.
Example 1f) In some embodiments, the first beam measurement is a measurement on the CSI-RS resource of the serving cell (e.g., CSI-RSRP, CSI-RSRQ, CSI-SINR, L1 RSRP of a CSI-RS resource, L1 RSRQ or SINR of a CSI-RS resource) which is configured as Quasi-Co-Location (QCL) of the currently activated TCI state.
Example 1g) In some embodiments, the first beam measurement is a measurement on the CSI-RS resource of the serving cell whose trigger quantity (e.g., RSRP, RSRQ, SINR, RSSI) is the strongest. For example, the wireless device 22 performs measurements on or more CSI-RS resources of the serving cell according to the trigger quantity (e.g., if trigger quantity is RSRQ, wireless device 22 obtains the CSI-RSRQ(1) for CSI-RS resource identifier=1, CSI-RSRQ(2) for CSI-RS resource identifier=2, . . . , CSI-RSRQ(n), . . . , CSI-RSRQ(N) for CSI-RS resource identifier=N, and selects the CSI-RS resource whose CSI-RSRQ is the strongest e.g. CSI-RSRQ(n)*, with CSI-RS resource identifier index=n*. The first measurement is the SS-RSRQ(n)*.
Example 1h) In some embodiments, the first beam measurement is a measurement on the CSI-RS resource of the serving cell (among the CSI-RS resources configured as QCL source(s) of TCI states of the current serving cell), e.g., whose trigger quantity (e.g. RSRP, RSRQ, SINR, RSSI) is the strongest.
Example 1i) In some embodiments, the first beam measurement is a measurement on the CSI-RS resources of the serving cell (among the CSI-RS resources configured as QCL source(s) of TCI states of the current serving cell and excluding the CSI-RS resource which is QCL of an activated TCI state), e.g., whose trigger quantity (e.g., RSRP, RSRQ, SINR, RSSI) is the strongest.
Example 1j) In some embodiments, the first measurement is a combination of measurements on at least one CSI-RS resource (e.g., CSI-RSRP, CSI-RSRQ, CSI-SINR, L1 RSRP of a CSI-RS resource, L1 RSRQ or SINR of a CSI-RS resource) and at least one SSB of the serving cell (e.g., SS-RSRP, SS-RSRQ, SS-SINR, L1 RSRP of an SSB, L1 RSRQ or SINR of an SSB) which are configured as Quasi-Co-Location (QCL) sources of one or more currently activated TCI states.
Example 1k) In some embodiments, the first measurement is a measurement on the CSI-RSs of the serving cell among the CSI-RSs configured as QCL source(s) of TCI states of the current serving cell in the currently activated BWP, e.g., whose trigger quantity (e.g. RSRP, RSRQ, SINR, RSSI) is the strongest.

In some embodiments, the first beam measurement is a measurement of a cell (e.g., PCell, PSCell, SCell of the MCG, SCell of the SCG) whose associated TCI state is currently activated. The measurement may correspond to a measurement (e.g., an RSRP, RSRQ, SINR, RSSI, any other quality measurement, received signal power measurement value) performed on a reference signal (RS) and/or synchronization signal (SS) of that serving cell, such as an SSB and/or CSI-RS of the serving cell, where the RS and/or SS may the transmitted in a spatial direction (also referred to as a beam), so that the first measurement may be referred to as a beam measurement. That measurement may reflect the quality of the beam serving the wireless device 22, e.g., correlated to the quality of ongoing transmissions of control and data channels to the wireless device 22.
In one embodiment, the first measurement is a measurement on the SSB which is configured as Quasi-Co-Location (QCL) of the currently activated TCI state.
In one embodiment, the first measurement is a measurement on the CSI-RS resource which is configured as Quasi-Co-Location (QCL) of the currently activated TCI state.

In some embodiments, the second beam measurement (also referred to as second measurement) is a measurement of an L1/L2 inter-cell mobility candidate cell (e.g., in the same serving frequency as the PCell, PSCell, SCell of the MCG, SCell of the SCG, or in another frequency). The second beam measurement may correspond to a measurement (e.g., an RSRP, RSRQ, SINR, RSSI, any other quality measurement, received signal power measurement value) performed on a reference signal (RS) and/or synchronization signal (SS) of that serving cell, such as an SSB and/or CSI-RS of that L1/L2 inter-cell mobility candidate cell, where the RS and/or SS may the transmitted in a spatial direction (also referred to as a beam), so that the second measurement may be referred to as a beam measurement. That measurement may reflect the quality of a beam which may serve the wireless device 22 after L1/L2 inter-cell mobility execution. By way of further example:
Example 2a) In some embodiments, the second beam measurement is a measurement on the SSB of the L1/L2 inter-cell mobility candidate cell (e.g., SS-RSRP, SS-RSRQ, SS-SINR, L1 RSRP of an SSB, L1 RSRQ or SINR of an SSB) which is configured as Quasi-Co-Location (QCL) of a TCI state of the L1/L2 inter-cell mobility candidate cell. Not all SSBs may be considered for second beam measurements and as input to the triggering condition(s).
Example 2b) In some embodiments, the second beam measurement is a measurement on the SSB of the L1/L2 inter-cell mobility candidate cell whose trigger quantity (e.g., RSRP, RSRQ, SINR, RSSI) is the strongest. For example, the wireless device 22 performs measurements on or more SSBs of the L1/L2 inter-cell mobility candidate cell according to the trigger quantity (e.g., if trigger quantity is RSRP, the wireless device 22 obtains the SS-RSRP(1) for SSB index=1, SS-RSRP(2) for SSB index=2, . . . , SS-RSRP(k), . . . , SS-RSRP(K) for SSB index=K, and selects the SSB whose SS-RSRP is the strongest e.g. SS-RSRP(k)*, with SSB index=k*. The second beam measurement is the SS-RSRP(k)*.
Example 2c) In some embodiments, the second beam measurement is a measurement on the SSB of the L1/L2 inter-cell mobility candidate cell (among the SSBs configured as QCL source(s) of TCI states) whose trigger quantity (e.g., RSRP, RSRQ, SINR, RSSI) is the strongest. For example, the wireless device 22 perform measurements on or more SSBs of the L1/L2 inter-cell mobility candidate cell (among the SSBs configured as QCL source(s) of TCI states of the L1/L2 inter-cell mobility candidate cell) and selects the strongest. In other words, SSBs of candidate beams (e.g., configured as QCL source type D) are considered, but not all SSBs of that L1/L2 inter-cell mobility candidate cell.
Example 2d) In some embodiments, the second beam measurement is a measurement on the SSB of the L1/L2 inter-cell mobility candidate cell among the SSBs configured as QCL source(s) of TCI states of the L1/L2 inter-cell mobility candidate cell having an overlapping BQP with the currently activated Bandwidth Part (BWP) of the serving cell in the same serving frequency, e.g., whose trigger quantity (e.g. RSRP, RSRQ, SINR, RSSI) is the strongest.
Example 2e) In some embodiments, the second beam measurement is a measurement on any SSB of the L1/L2 inter-cell mobility candidate cell (e.g., SS-RSRP, SS-RSRQ, SS-SINR, L1 RSRP of an SSB, L1 RSRQ or SINR of an SSB).
Example 2f) In some embodiments, the second beam measurement is a measurement on the CSI-RS resource of the L1/L2 inter-cell mobility candidate cell which is configured as Quasi-Co-Location (QCL) of a TCI state of the L1/L2 inter-cell mobility candidate cell. Like that, not all CSI-RS resources are considered for second beam measurements and as input to the triggering condition(s).
Example 2g) In some embodiments, the second beam measurement is a measurement on the CSI-RS resource of the L1/L2 inter-cell mobility candidate cell whose trigger quantity (e.g. RSRP, RSRQ, SINR, RSSI) is the strongest.
Example 2h) In some embodiments, the second beam measurement is a measurement on the CSI-RS resource of the L1/L2 inter-cell mobility candidate cell (among the CSI-RS resources configured as QCL source(s) of TCI states) whose trigger quantity (e.g., RSRP, RSRQ, SINR, RSSI) is the strongest.
Example 2i) In some embodiments, the first measurement is a measurement on the CSI-RS resources of the L1/L2 inter-cell mobility candidate cell among the CSI-RS resources configured as QCL source(s) of TCI states of the L1/L2 inter-cell mobility candidate cell having an overlapping BWP with the currently activated Bandwidth Part (BWP) of the serving cell in the same serving frequency, e.g., whose trigger quantity (e.g., RSRP, RSRQ, SINR, RSSI) is the strongest.
Example 2j) In some embodiments, the second beam measurement is a measurement on any CSI-RS resource of the L1/L2 inter-cell mobility candidate cell.

In some embodiments, a second beam measurement includes one or more of:
Synchronization Signal (SS) Reference Signal Received Power (SS-RSRP) of a L1/L2 inter-cell mobility candidate cell, for at least one configured/indicated SSB of the L1/L2 inter-cell mobility candidate cell. The SS-RSRP is measured only among the reference signals corresponding to SS/PBCH blocks (SSBs) with the same SS/PBCH block (SSB) index and the same physical-layer cell identity (PCI) of the L1/L2 inter-cell candidate cell.
   In some embodiments, the SS-RSRP may be derived as the linear average over the power contributions (in [W], e.g., watts) of the resource elements that carry secondary synchronization signals (SSSs) of the L1/L2 inter-cell candidate cell.
   In some embodiments, the SS-RSRP determination is based on the demodulation reference signals for physical broadcast channel (PBCH) of the L1/L2 inter-cell candidate cell; and, if indicated by higher layers, CSI reference signals of the L1/L2 inter-cell candidate cell, in addition to secondary synchronization signals may be used.
   In some embodiments, the SS-RSRP indicate certain SS/PBCH blocks for performing SS-RSRP measurements, then SS-RSRP is measured only from the indicated set of SS/PBCH block(s).
   In some embodiments, the SS-RSRP is used for L1-RSRP to be included in a CSI report;
SS reference signal received quality (SS-RSRQ) of a L1/L2 inter-cell mobility candidate cell, for at least one configured/indicated SSB of the L1/L2 inter-cell mobility candidate cell.
SS signal-to-noise and interference ratio (SS-SINR) of a L1/L2 inter-cell mobility candidate cell, for at least one configured/indicated SSB of the L1/L2 inter-cell mobility candidate cell.
CSI Reference Signal Received Power (CSI-RSRP) of a L1/L2 inter-cell mobility candidate cell, for at least one configured/indicated CSI-RS resource of the L1/L2 inter-cell mobility candidate cell.
   In one embodiment, the CSI-RSRP comprises the linear average over the power contributions (in [W]) of the resource elements of the antenna port(s) that carry CSI reference signals configured for RSRP measurements within the considered measurement frequency bandwidth in the configured CSI-RS occasions, for the L1/L2 inter-cell mobility candidate cell.
CSI reference signal received quality (CSI-RSRQ) of a L1/L2 inter-cell mobility candidate cell, for at least one configured/indicated CSI-RS resource of the L1/L2 inter-cell mobility candidate cell.
CSI signal-to-noise and interference ratio (CSI-SINR) of a L1/L2 inter-cell mobility candidate cell, for at least one configured/indicated CSI-RS resource of the L1/L2 inter-cell mobility candidate cell.
Layer 1 Reference Signal Received Power (L1-RSRP) based on at least one SSB of a L1/L2 inter-cell mobility candidate cell.
Layer 1 Reference Signal Received Power (L1-RSRP) based on at least one CSI-RS resource of a L1/L2 inter-cell mobility candidate cell.
Layer 1 SINR (L1-SINR) based on at least one SSB of a L1/L2 inter-cell mobility candidate cell.
Layer 1 SINR (L1-SINR) based on at least one CSI-RS resource of a L1/L2 inter-cell mobility candidate cell.
Channel Quality Indicator (CQI) of a L1/L2 inter-cell mobility candidate cell, based on SSB and/or CSI-RS in the CSI resource configuration;
precoding matrix indicator (PMI) of a L1/L2 inter-cell mobility candidate cell, based on SSB and/or CSI-RS in the CSI resource configuration;
CSI-RS resource indicator (CRI) of a L1/L2 inter-cell mobility candidate cell, based on SSB and/or CSI-RS in the CSI resource configuration;
SS/PBCH Block Resource indicator (SSBRI) of a L1/L2 inter-cell mobility candidate cell, based on SSB and/or CSI-RS in the CSI resource configuration;
Layer indicator (LI) of a L1/L2 inter-cell mobility candidate cell, based on SSB and/or CSI-RS in the CSI resource configuration;
Rank indicator (RI) of a L1/L2 inter-cell mobility candidate cell, based on SSB and/or CSI-RS in the CSI resource configuration.

In some embodiments, the wireless device 22 determines that candidate cell by receiving the L1/L2 inter-cell mobility target candidate configuration (to be applied when switching to that cell upon execution of L1/L2 inter-cell mobility), as generated by the target candidate Distributed Unit (DU) at the network/network node 16, in an intra-CU inter-DU scenario, or/and determine that candidate cell by receiving a CSI measurement configuration (e.g., generated by the Serving DU) indicating that candidate cells to be measured.

### Examples of the One or More Trigger Condition(s) (e.g., Event Criteria/Criterion)

In some embodiments, the one event configuration indicates one or more trigger condition(s) based on a first beam measurement and/or a second beam measurement, where the first measurement is of a serving cell (e.g., PCell) and the second measurement is of a L1/L2 inter-cell mobility candidate cell.

The first beam measurement may be at least any of Examples 1a, 1b, 1c, 1d, 1e, 1f, 1g, 1h, 1i, 1j, and 1k.

The second beam measurement may be at least any of Examples 2a, 2b, 2c, 2d, 2e, 2f, 2g, 2h, 2i, and 2j.

In some embodiments, the one or more trigger condition(s) are considered fulfilled when the second beam measurement is an offset better (e.g., greater) than the first beam measurement.
This is applicable for any combination of the first beam measurement (e.g., Examples 1a, 1b, 1c, 1d, 1e, 1f, 1g, 1h, 1i, 1j, 1k) with the second beam measurement (e.g., Examples 2a, 2b, 2c, 2d, 2e, 2f, 2g, 2h, 2i, 2j), as the examples in the following.
(combination of Examples 2a and 1a) In one embodiment, the wireless device 22 transmits a lower layer beam report when the measurement on the SSB of the L1/L2 inter-cell mobility candidate cell (e.g., SS-RSRP, SS-RSRQ, SS-SINR, L1 RSRP of an SSB, L1 RSRQ or SINR of an SSB) which is configured as Quasi-Co-Location (QCL) of a TCI state of the L1/L2 inter-cell mobility candidate cell, is an offset better/greater (offset+threshold) than the measurement on the SSB of the serving cell (e.g., SS-RSRP, SS-RSRQ, SS-SINR, L1 RSRP of an SSB, L1 RSRQ or SINR of an SSB) which is configured as Quasi-Co-Location (QCL) of an activated TCI state.
   The report may be triggered to indicated to the network node 16 that a beam in a candidate cell (SSB which is QCL of a TCI state configured in the L1/L2 inter-cell mobility candidate cell) is an offset better (according to a quantity like RSRP) than the currently activated beam ((SSB which is QCL of the active TCI state of the serving cell). Without that embodiment, the wireless device 22 may transmit periodically one or more SSBs of the serving cell and candidate cells for L1/L2 inter-cell mobility, which would be a waste of UL resources, as the timing defined by the event may be of the most interest to the network node 16, when the wireless device 22 identifies there is a better beam in another cell compared to the beam currently serving the wireless device 22. In response to that report, the wireless device 22 may possibly receive a lower layer signaling indicating the execution of L1/L2 inter-cell mobility to the SSB of the candidate cell which has been reported and/or the TCI state of the L1/L2 inter-cell mobility candidate cell whose QCL source is the reported SSB.
(combination of Examples 2a and 1b) In one embodiment, the wireless device 22 transmits a lower layer beam report when the measurement on the SSB of the L1/L2 inter-cell mobility candidate cell (e.g., SS-RSRP, SS-RSRQ, SS-SINR, L1 RSRP of an SSB, L1 RSRQ or SINR of an SSB) which is configured as Quasi-Co-Location (QCL) of a TCI state of the L1/L2 inter-cell mobility candidate cell, is an offset better (offset+threshold) than the measurement on the SSB of the serving cell whose trigger quantity (e.g., RSRP, RSRQ, SINR, RSSI) is the strongest (regardless if that is the SSB of the currently activated SSB).
   The report may be triggered to indicate to the network node 16 that a beam in a candidate cell (SSB which is QCL of a TCI state configured in the L1/L2 inter-cell mobility candidate cell) is an offset better (e.g., greater) (according to a quantity like RSRP) than the strongest beam in the serving cell, because even if it is not currently being used, the network node 16 may at any time activate it in an intra-cell beam switching, e.g., by activating a TCI state of the serving cell. Without this embodiment and/or teaching, the wireless device 22 would possibly transmit periodically one or more SSBs of the serving cell and candidate cells for L1/L2 inter-cell mobility, which would be a waste of UL resources, as the timing defined by the event may be of the most interest to the network node 16, when the wireless device 22 identifies there is a better beam in another cell compared to the best beam of the current serving cell, which is a more likely candidate. In response to that report, the wireless device 22 may possibly receive a lower layer signaling indicating the execution of L1/L2 inter-cell mobility to the SSB of the candidate cell which has been reported and/or the TCI state of the L1/L2 inter-cell mobility candidate cell whose QCL source is the reported SSB.

In a set of embodiments, the one or more trigger condition(s) are considered fulfilled (e.g., event criteria/criterion is met) when the first beam measurement is below a threshold1
This is applicable for any example of first beam measurement (e.g., Examples 1a, 1b, 1c, 1d, 1e, 1f, 1g, 1h, 1i, 1j, 1k)
In one embodiment, the wireless device 22 transmits a lower layer beam report when the measurement on the SSB of the serving cell (e.g., SS-RSRP, SS-RSRQ, SS-SINR, L1 RSRP of an SSB, L1 RSRQ or SINR of an SSB) which is configured as Quasi-Co-Location (QCL) of an activated TCI state is below threshold1.
   The report is triggered to indicate to the network node 16 that the beam currently used to serve the wireless device 22 has a poor quality, below a threshold, which may indicate that the quality (according to a measurement quantity) is below an acceptable level, and that an action may need to be performed by the network node 16 unless a beam failure and/or radio link failure may be triggered (as that usually takes a bit longer, so there may be time for the network node 16 to recover before it happens). Without this embodiment and/or teaching, the wireless device 22 would possibly transmit periodically the SSB associated to the activated TCI state, which would be a waste of UL resources, as the timing defined by the event may be of the most interest to the network node 16, when the wireless device 22 identifies there is a problem. In response to that report, the wireless device 22 may possibly receive a lower layer signaling activating further CSI measurements on that serving cell, so the network node 16 becomes aware of which other SSBs (and consequently beams and TCI states) are better candidates for intra-cell mobility.
In addition to Example 1b) In one embodiment, the wireless device 22 transmits a lower layer beam report when the measurement on the SSB of the serving cell whose trigger quantity (e.g., RSRP, RSRQ, SINR, RSSI) is the strongest is below threshold1.
   The report is triggered to indicate to the network node that the best beam, which may possibly serve the wireless device 22 in that cell, has a poor quality, below a threshold, which may indicate that even the best possible quality (according to a measurement quantity) is below an acceptable level, and that an action may need to be performed by the network node 16. Without this embodiment and/or teaching, the wireless device 22 would possibly transmit periodically the SSB associated to the activated TCI state, which would be a waste of UL resources, as the timing defined by the event may be of the most interest to the network node 16, when the wireless device 22 identifies there is a problem. In response to that report, the wireless device 22 may possibly receive a lower layer signaling activating further CSI measurements on that serving cell, so the network/network node 16 becomes aware of which other SSBs (and consequently beams and TCI states) are better candidates for intra-cell mobility.
In addition to Example 1c) In one embodiment, the wireless device 22 transmits a lower layer beam report when the measurement on the SSB of the serving cell (among the SSBs configured as QCL source(s) of TCI states of the current serving cell), e.g., whose trigger quantity (e.g. RSRP, RSRQ, SINR, RSSI) is the strongest is below threshold1.
In addition to Example 1d) In one embodiment, the wireless device 22 transmits a lower layer beam report when the measurement on the SSB of the serving cell (among the SSBs configured as QCL source(s) of TCI states of the current serving cell and excluding the SSB which is QCL of an activated TCI state), e.g., whose trigger quantity (e.g., RSRP, RSRQ, SINR, RSSI) is the strongest is below threshold1.
In addition to Example 1e) In one embodiment, the wireless device 22 transmits a lower layer beam report when the measurement on the SSB of the serving cell among the SSBs configured as QCL source(s) of TCI states of the current serving cell in the currently activated Bandwidth Part (BWP), e.g., whose trigger quantity (e.g., RSRP, RSRQ, SINR, RSSI) is the strongest is below threshold1.

In a set of embodiments, the one or more trigger condition(s) are considered fulfilled (e.g., event criterion/criteria is met) when the first beam measurement is above a threshold2
This is applicable for any example of first beam measurement (e.g., Examples 1a, 1b, 1c, 1d, 1e, 1f, 1g, 1h, 1i, 1j, and 1k)
In addition to Example 1d) In one embodiment, the wireless device 22 transmits a lower layer beam report when the measurement on the SSB of the serving cell (among the SSBs configured as QCL source(s) of TCI states of the current serving cell and excluding the SSB which is QCL of an activated TCI state), e.g., whose trigger quantity (e.g., RSRP, RSRQ, SINR, RSSI) is the strongest is above threshold2.

In some embodiments, the one or more trigger condition(s) are considered fulfilled (e.g., event criterion/criteria is met) when the second beam measurement is below a threshold3
This is applicable at least for the example of second beam measurement (e.g., Examples 2a, 2b, 2c, 2d, 2e, 2f, 2g, 2h, 2i and 2j), as the examples in the following.

In some embodiments, the one or more trigger condition(s) is considered fulfilled (e.g., event criterion/criteria is met) when the second beam measurement is above a threshold4
This is applicable at least for the example of second beam measurement (e.g., Examples 2a, 2b, 2c, 2d, 2e, 2f, 2g, 2h, 2i and 2j), as the examples in the following.

In a set of embodiment, the one or more triggering condition(s) is considered fulfilled (e.g., event criterion/criteria is met) when the first beam measurement is below a threshold5 and the second beam measurement is above a threshold6
This is applicable for any combination of the first beam measurement (e.g., Examples 1a, 1b, 1c, 1d, 1e, 1f, 1g, 1h, 1i, 1j and 1k) with the second beam measurement (e.g., Examples 2a, 2b, 2c, 2d, 2e, 2f, 2g, 2h, 2i and 2j), as the examples in the following.

In one embodiment, the wireless device 22 transmits a lower layer beam report when the measurement on the SSB of the serving cell (e.g., SS-RSRP, SS-RSRQ, SS-SINR, L1 RSRP of an SSB, L1 RSRQ or SINR of an SSB) which is configured as Quasi-Co-Location (QCL) of an activated TCI state is below threshold5 and when the measurement on the SSB of the L1/L2 inter-cell mobility candidate cell (e.g., SS-RSRP, SS-RSRQ, SS-SINR, L1 RSRP of an SSB, L1 RSRQ or SINR of an SSB) which is configured as Quasi-Co-Location (QCL) of a TCI state of the L1/L2 inter-cell mobility candidate cell is above a threshold6.

### Transmitting a Lower Layer Measurement Report to the Network/Network Node 16

In a set of embodiments, a lower layer report includes a report defined in the Layer 1 (also called Physical Layer or L1) and includes a report over a Physical Uplink Control Channel (PUCCH) or a Physical Uplink Shared Channel (PDSCH), including the first beam measurement and/or the second beam measurement.

In a set of embodiments, a lower layer report comprises a report defined in the Medium Access Control (MAC) layer 1. That may include a MAC CE transmitted to the network node 16 including the first beam measurement and/or the second beam measurement. When the event is triggered, the wireless device 22 sends an SR (if no UL resources are available) to obtain an UL grant to transmit the MAC CE for the lower layer measurement report.

Wireless Device 22 Capabilities Associated with One or More Embodiments

In a set of embodiments, the wireless device 22 indicates to the network node 16 that is capable of triggering a lower layer measurement report based on an event-triggered configuration. The indication may indicate that the wireless device 22 supports one or more the events (and triggered conditions). In another example, the indication may further include one or more parameters and/or fields and/or IE(s) indicating one or more of:
What events or triggering conditions are supported by the wireless device 22
What measurement quantities are supported for each supported event or triggering condition.

One of the advantages of defining a lower layer measurement report to assist network decisions on L1/L2 inter-cell mobility is that these measurements are processed by a DU (e.g. Serving DU), otherwise, if these would have been RRC measurement reports (e.g. within an RRC MeasurementReport message defined in 3GPP TS 38.331) these would need to go to the CU to be processed, to only then indicated to the DU. A lower layer report, assisting L1/L2 inter-cell mobility executions is in a format understood by the Serving DU (or Candidate DU).

One or more embodiments described herein may provide one or more of the advantages described below.

Lower layer measurements report in existing systems, such as CSI reports/beam reports (when including measurements on beams reported by the wireless device and assisting the network/network node 16 to perform beam management), are currently configured as periodic, aperiodic or semi-persistent.

The design of efficient events (or trigger conditions), as described herein, for the wireless device 22 to trigger lower layer measurement reports to assist the network node 16 in performing L1/L2 inter-cell mobility decisions reduces the amount of UL overhead, as the wireless device 22 only transmits the lower layer measurement reports when conditions mapped to what the network node 16 believes to be relevant to indicate a need to trigger a L1/L2 inter-cell mobility execution are fulfilled, e.g., when a predefined event criterion is met. For example, lower layer reports would not be transmitted by the wireless device 22 when the current beam serving the wireless device 22 is still determined by, for example, the wireless device 22 to be the best beam, e.g., if the SSB and/or CSI-RS configured as QCL source of the current active TCI state has the strongest Layer 1 RSRP and/or RSRQ and/or SINR.

Another advantage may be the reduction in wireless device 22 power consumption, as fewer lower measurement reports would be transmitted if defined as event-triggered lower layer measurement reports, compared to the transmission/configuration of periodic reports.

Another advantage may relate to reliability. In an aperiodic report, the network node 16 needs to activate the report from the wireless device 22 of beam measurements. However, this may occur when radio conditions are not ideal, so that the wireless device 22 may not be able to receive the activation command and/or may not be able to transmit the report. In event-triggered reporting described herein, the wireless device detects the fulfillment of the event and transmits the report to the network node 16, without the need to receive a command right before.

In case where the wireless device 22 is configured with multiple L1/L2 inter-cell mobility candidate cells, the potential number of reports would increase, e.g., when close to the cell edge (e.g., in the case of an event defined as a beam of a L1/L2 inter-cell mobility candidate better than the serving beam of current serving cell). However, advantageously due to event triggered reporting for lower layer measurements described herein, only relevant L1/L2 inter-cell candidate cells and/or beams of these L1/L2 inter-cell candidate cells are reported to the network node 16, which reduces the amount of reports, but also the overhead in each report.

For each event described herein, further advantages are explained herein as well.

### EXAMPLES

Example A1. A network node 16 configured to communicate with a wireless device 22, the network node 16 configured to, and/or comprising a radio interface 62 and/or comprising processing circuitry 68 configured to:
cause transmission of at least one event criterion for the wireless device 22 to trigger a lower layer measurement report, the event criterion being based on at least one of a first beam measurement and a second beam measurement, the first beam measurement being associated with a serving cell and the second beam measurement being associated with a Layer 1/Layer 2, L1/L2, inter-cell mobility candidate cell;
receive the lower layer measurement report according to the at least one event criterion; and
determine L1/L2 inter-cell mobility based at least on the lower layer measurement report.

Example A2. The network node 16 of Example A1, wherein the at least one event criterion is transmitted via radio resource control, RRC, signaling.

Example A3. The network node 16 of Example A1, wherein the lower layer measurement report includes at least one of the first beam measurement and the second beam measurement.

Example A4. The network node 16 of Example A1, wherein the at least one event criterion is not met when a current beam serving the wireless device 22 has a stronger Layer 1 received signal received power, RSRP, received signal receive quality, RSRQ, and/or signal to interference plus noise ratio, SINR, than a remaining plurality of beams.

Example A5. The network node 16 of Example A1, wherein the at least one event criterion is met when the second beam measurement is offset greater than the first beam measurement.

Example A6. The network node 16 of Example A1, wherein the at least one event criterion is met when at least one of:
the first beam measurement is one of greater than and less than a first threshold; and
the second beam measurement is one of greater than and less than a second threshold.

Example A7. The network node 16 of Example A1, wherein the lower layer corresponds to a layer that is lower than the radio resource control, RRC, layer in a protocol stack.

Example B1. A method implemented in a network node 16 that is configured to communicate with a wireless device 22, the method comprising:
causing transmission of at least one event criterion for the wireless device 22 to trigger a lower layer measurement report, the event criterion being based on at least one of a first beam measurement and a second beam measurement, the first beam measurement being associated with a serving cell and the second beam measurement being associated with a Layer 1/Layer 2, L1/L2, inter-cell mobility candidate cell;
receiving the lower layer measurement report according to the at least one event criterion; and
determining L1/L2 inter-cell mobility based at least on the lower layer measurement report.

Example B2. The method of Example B1, wherein the at least one event criterion is transmitted via radio resource control, RRC, signaling.

Example B3. The method of Example B1, wherein the lower layer measurement report includes at least one of the first beam measurement and the second beam measurement.

Example B4. The method of Example B1, wherein the at least one event criterion is not met when a current beam serving the wireless device has a stronger Layer 1 received signal received power, RSRP, received signal receive quality, RSRQ, and/or signal to interference plus noise ratio, SINR, than a remaining plurality of beams.

Example B5. The method of Example B1, wherein the at least one event criterion is met when the second beam measurement is offset greater than the first beam measurement.

Example B6. The method of Example B1, wherein the at least one event criterion is met when at least one of:
the first beam measurement is one of greater than and less than a first threshold; and
the second beam measurement is one of greater than and less than a second threshold.

Example B7. The method of Example B1, wherein the lower layer corresponds to a layer that is lower than the radio resource control, RRC, layer in a protocol stack.

Example C1. A wireless device 22 configured to communicate with a network node 16, the wireless device 22 configured to, and/or comprising a radio interface 82 and/or processing circuitry 84 configured to:
perform at least one of a first beam measurement and a second beam measurement, the first beam measurement being associated with a serving cell and the second beam measurement being associated with a Layer 1/Layer 2, L1/L2, inter-cell mobility candidate cell.
determine whether at least one event criterion is met, the at least one event criterion being associated with triggering of a lower layer measurement report; and
cause transmission of the lower layer measurement report based on the at least one event criterion being met, the lower layer measurement report being configured to assist the network node 16 in L1/L2 inter-cell mobility.

Example C2. The wireless device 22 of Example C1, wherein the processing circuitry 84 is further configured to receive the at least one event criterion via radio resource control, RRC, signaling.

Example C3. The wireless device 22 of Example C1, wherein the lower layer measurement report includes at least one of the first beam measurement and the second beam measurement.

Example C4. The wireless device 22 of Example C1, wherein the at least one event criterion is not met when a current beam serving the wireless device 22 has a stronger Layer 1 received signal received power, RSRP, received signal receive quality, RSRQ, and/or signal to interference plus noise ratio, SINR, than a remaining plurality of beams.

Example C5. The wireless device 22 of Example C1, wherein the at least one event criterion is met when the second beam measurement is offset greater than the first beam measurement.

Example C6. The wireless device 22 of Example C1, wherein the at least one event criterion is met when at least one of:
the first beam measurement is one of greater than and less than a first threshold; and
the second beam measurement is one of greater than and less than a second threshold.

Example C7. The wireless device 22 of Example C1, wherein the lower layer corresponds to a layer that is lower than the radio resource control, RRC, layer in a protocol stack.

Example D1. A method implemented in a wireless device 22 that is configured to communicate with a network node 16, the method comprising:
performing at least one of a first beam measurement and a second beam measurement, the first beam measurement being associated with a serving cell and the second beam measurement being associated with a Layer 1/Layer 2, L1/L2, inter-cell mobility candidate cell;
determining whether at least one event criterion is met, the at least one event criterion being associated with triggering of a lower layer measurement report; and
causing transmission of the lower layer measurement report based on the at least one event criterion being met, the lower layer measurement report being configured to assist the network node 16 in L1/L2 inter-cell mobility.

Example D2. The method of Example D1, further comprising receiving the at least one event criterion via radio resource control, RRC, signaling.

Example D3. The method of Example D1, wherein the lower layer measurement report includes at least one of the first beam measurement and the second beam measurement.

Example D4. The method of Example D1, wherein the at least one event criterion is not met when a current beam serving the wireless device 22 has a stronger Layer 1 received signal received power, RSRP, received signal receive quality, RSRQ, and/or signal to interference plus noise ratio, SINR, than a remaining plurality of beams.

Example D5. The method of Example D1, wherein the at least one event criterion is met when the second beam measurement is offset greater than the first beam measurement.

Example D6. The method of Example D1, wherein the at least one event criterion is met when at least one of:
the first beam measurement is one of greater than and less than a first threshold; and
the second beam measurement is one of greater than and less than a second threshold.

Example D7. The method of Example D1, wherein the lower layer corresponds to a layer that is lower than the radio resource control, RRC, layer in a protocol stack.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A method implemented in a wireless device that is configured to communicate with a network node, the method comprising:
performing a first beam measurement of a serving cell and a second beam measurement associated with an inter-cell mobility candidate cell;
determining at least one event criterion is met based on at least one of the first beam measurement and the second beam measurement; and
triggering at least one measurement report in a layer lower than a radio resource control, RRC, layer based on the determination.

2. The method of claim 1, wherein the measurement report is a channel state information, CSI, report; and
the method further comprises receiving a CSI report configuration indicating the at least one event criterion.

3. The method of claim 2, wherein the CSI report configuration indicates a reporting configuration of at least one of:
at least one inter-cell mobility candidate cell to be measured for which measurements are compared in the at least one event criterion; and
frequency information associated with at least one inter-cell mobility candidate cell for which measurements are compared in the at least one event criterion.

4. The method of claim 1, wherein at least one of the first beam measurement and the second beam measurement corresponds to a measurement performed on at least one of a reference signal and synchronization signal of the serving cell.

5. The method of claim 1, wherein the first beam measurement corresponds to a measurement of one of a synchronization signal block, SSB, and a channel state information-reference signal, CSI-RS, resource of the serving cell.

6. The method of claim 5, wherein the first beam measurement corresponds to the measurement of the SSB, the SSB being one of:
configured with a quasi-co-location, QCL, of an activated transmission configuration indicator, TCI, state;
associated with a measurement quantity greater than measurement quantities of remaining SSBs of a plurality of SSB of the serving cell;
associated with a measurement quantity greater than measurement quantities of remaining SSBs of a plurality of SSBs of the serving cell that are configured as at least one QCL source; and
associated with a measurement quantity greater than measurement quantities of remaining SSBs of a plurality of SSBs of the serving cell that are configured as at least one QCL source of at least one TCI state of a current serving cell in an activated bandwidth part, BWP.

7. The method of claim 1, wherein the second beam measurement corresponds to a measurement of one of a synchronization signal block, SSB, and a channel state information-reference signal, CSI-RS, resource of the inter-cell mobility candidate cell.

8. The method of claim 7, wherein the second beam measurement corresponds to the measurement of the SSB, the SSB being one of:
configured as a quasi-co-location, QCL, of a transmission configuration indicator, TCI, state of the inter-cell mobility candidate cell;
associated with a measurement quantity greater than other SSBs of a plurality of SSBs of the inter-cell mobility candidate cell;
associated with a measurement quantity greater than other SSBs of a plurality of SSBs of the inter-cell mobility candidate cell that are configured as at least one QCL source of at least one TCI state; and
associated with a measurement quantity greater than other SSBs of a plurality of SSBs of the inter-cell mobility candidate cell that are configured as at least one QCL source of at least one TCI state of the inter-cell mobility candidate cell having an overlapping bandwidth part, BWP, with an activated BWP of the serving cell in a same frequency of the serving cell.

9. The method of claim 7, wherein the second beam measurement corresponds to the measurement of the CSI-RS resource, the CSI-RS resource being one of:
associated with a measurement quantity greater than other CSI-RS resources of a plurality of CSI-RS resources of the inter-cell mobility candidate cell;
associated with a measurement quantity greater than other CSI-RS resources of a plurality of CSI-RS resources of the inter-cell mobility candidate cell that are configured as at least one QCL source of at least one TCI state; and
associated with a measurement quantity greater than other CSI-RS resources of a plurality of CSI-RS resources of the inter-cell mobility candidate cell that are configured as at least one QCL source of at least one TCI state of the inter-cell mobility candidate cell having an overlapping bandwidth part, BWP, with an activated BWP of the serving cell in a same frequency of the serving cell.

10. The method of claim 1, wherein the at least one event criterion defines at least one trigger condition that is configured to trigger the measurement report, the at least one trigger condition comprises one of:
the second beam measurement being offset greater than the first beam measurement;
the first beam measurement is one of greater than and lower than a threshold;
the second beam measurement one of greater than and lower than a threshold; and
the first beam measurement is less than a first threshold and the second beam measurement is greater than a second threshold.

11. (canceled)

12. (canceled)

13. A wireless device configured to communicate with a network node, the wireless device configured to:
perform a first beam measurement of a serving cell and a second beam measurement associated with an inter-cell mobility candidate cell;
determine at least one event criterion is met based on at least one of the first beam measurement and the second beam measurement; and
trigger at least one measurement report in a layer lower than a radio resource control, RRC, layer based on the determination.

14. The wireless device of claim 13, wherein the measurement report is a channel state information, CSI, report; and
the wireless device is further configured to receive a CSI report configuration indicating the at least one event criterion.

15.-24. (canceled)

25. A method implemented by a network node that is configured to communicate with a wireless device, the method comprising:
causing transmission of an indication of at least one event criterion, the at least one event criterion being configured to cause the wireless device to trigger a measurement report in a layer lower than a radio resource control, RRC, layer and being based on at least one of:
a first beam measurement of a serving cell; and
a second beam measurement associated with an inter-cell mobility candidate cell for a layer lower than the RRC layer; and
receiving the measurement report according to the at least one event criterion.

26. The method of claim 25, further comprising determining inter-cell mobility based at least on the measurement report.

27. The method of claim 25, wherein the measurement report is a channel state information, CSI, report; and
the at least one event criterion is indicated in a CSI report configuration.

28. The method of claim 27, wherein the CSI report configuration indicates a reporting configuration of at least one of:
at least one inter-cell mobility candidate cell to be measured for which measurements are compared in the at least one event criterion; and
frequency information associated with at least one inter-cell mobility candidate cell for which measurements are compared in the at least one event criterion.

29. (canceled)

30. The method of claim 25, wherein the first beam measurement corresponds to a measurement of one of a synchronization signal block, SSB, and a channel state information-reference signal, CSI-RS, resource of the serving cell.

31. The method of claim 30, wherein the first beam measurement corresponds to the measurement of the SSB, the SSB being one of:
configured with a quasi-co-location, QCL, of an activated transmission configuration indicator, TCI, state;
associated with a measurement quantity greater than measurement quantities of remaining SSBs of a plurality of SSB of the serving cell;
associated with a measurement quantity greater than measurement quantities of remaining SSBs of a plurality of SSBs of the serving cell that are configured as at least one QCL source; and
associated with a measurement quantity greater than measurement quantities of remaining SSBs of a plurality of SSBs of the serving cell that are configured as at least one QCL source of at least one TCI state of a current serving cell in an activated bandwidth part, BWP.

32. The method of claim 25, wherein
the second beam measurement corresponds to a measurement of one of a synchronization signal block, SSB, and a channel state information-reference signal, CSI-RS, resource of the inter-cell mobility candidate cell.

33. The method of claim 32, wherein the second beam measurement corresponds to the measurement of the SSB, the SSB being one of:
configured as a quasi-co-location, QCL, of a transmission configuration indicator, TCI, state of the inter-cell mobility candidate cell;
associated with a trigger quantity greater than other SSBs of a plurality of SSBs of the inter-cell mobility candidate cell;
associated with a trigger quantity greater than other SSBs of a plurality of SSBs of the inter-cell mobility candidate cell that are configured as at least one QCL source of at least one TCI state; and
associated with a trigger quantity greater than other SSBs of a plurality of SSBs of the inter-cell mobility candidate cell that are configured as at least one QCL source of at least one TCI state of the inter-cell mobility candidate cell having an overlapping bandwidth part, BWP, with a currently activated BWP of the serving cell in a same frequency of the serving cell.

34. (canceled)

35. The method of claim 25, wherein
the at least one event criterion defines at least one trigger condition that is configured to trigger the measurement report, the at least one trigger condition comprises one of:
the second beam measurement being offset greater than the first beam measurement;
the first beam measurement is one of greater than and lower than a threshold;
the second beam measurement one of greater than and lower than a threshold; and
the first beam measurement is less than a first threshold and the second beam measurement is greater than a second threshold.

36. (canceled)

37. (canceled)

38. A network node configured to communicate with a wireless device, the network node configured to:
cause transmission of an indication of at least one event criterion, the at least one event criterion being configured to cause the wireless device to trigger a measurement report in a layer lower than a radio resource control, RRC, layer and being based on at least one of:
a first beam measurement of a serving cell; and
a second beam measurement associated with an inter-cell mobility candidate cell for a layer lower than the RRC layer; and
receive the measurement report according to the at least one event criterion.

39. The network node of claim 38, wherein the network node is further configured to determine inter-cell mobility based at least on the measurement report.

40.-52. (canceled)
